(19) United States
(12) Patent Application Publication
(10) Pub. No.: US 2025/0239182 A1
(43) Pub. Date: Jul. 24, 2025

(54) HEAD AND NECK SYSTEM FOR A PATIENT SIMULATOR

(71) Applicant: GAUMARD SCIENTIFIC COMPANY, INC., Miami, FL (US)

(72) Inventor: Allan R. KIRCHHOFF, Miami, FL (US)

(21) Appl. No.: 19/029,014

(22) Filed: Jan. 17, 2025

Related U.S. Application Data
(60) Provisional application No. 63/623,107, filed on Jan. 19, 2024.

(51) Int. Cl. G09B 23/32

(52) U.S. Cl. CPC G09B 23/32

(57) ABSTRACT

A head and neck system for a patient simulator, which head and neck system includes one or any combination of: a sweat and tears subsystem; a jaw movement subsystem; a neck movement subsystem; an eyes subsystem; a brow movement subsystem; a lip movement subsystem; an airway subsystem; and one or more simulated skin layers adapted to cover the head and neck system for the patient simulator.

### CROSS-REFERENCE TO RELATED APPLICATION

This application claims the benefit of the filing date of, and priority to, U.S. Patent Application No. 63/623,107 (the “'107 Application”), filed Jan. 19, 2024, the entire disclosure of which is hereby incorporated herein by reference.

### TECHNICAL FIELD

The present disclosure relates generally to patient simulators, and, more particularly, to a head and neck system for a patient simulator, which head and neck system includes one or any combination of: a sweat and tears subsystem; a jaw movement subsystem; a neck movement subsystem; an eyes subsystem; a brow movement subsystem; a lip movement subsystem; an airway subsystem; and one or more simulated skin layers adapted to cover the head and neck system for the patient simulator.

### BRIEF DESCRIPTION OF THE DRAWINGS

FIG. 1A is a perspective view of a head and neck system for a patient simulator, according to one or more embodiments of the present disclosure.

FIG. 1B is a front elevation view of the head and neck system for the patient simulator of FIG. 1A, according to one or more embodiments of the present disclosure.

FIG. 1C is a side elevation view of the head and neck system for the patient simulator of FIG. 1A, according to one or more embodiments of the present disclosure.

FIG. 1D is another side elevation view of the head and neck system for the patient simulator of FIG. 1A, according to one or more embodiments of the present disclosure.

FIG. 1E is an exploded perspective view of the head and neck system for the patient simulator of FIGS. 1A, according to one or more embodiments of the present disclosure.

FIG. 2A is a perspective view of a sweat and tears subsystem of the head and neck system for the patient simulator of FIGS. 1A-1E, according to one or more embodiments of the present disclosure.

FIG. 2B another perspective view of the sweat and tears subsystem of FIG. 2A, according to one or more embodiments of the present disclosure.

FIG. 3A is a perspective view of a jaw movement subsystem of the head and neck system for the patient simulator of FIGS. 1A-1E, according to one or more embodiments of the present disclosure.

FIG. 3B is a perspective view of the jaw movement subsystem of FIG. 3A interfacing with one or more simulated skin layers adapted to cover the head and neck system for the patient simulator of FIGS. 1A-1E, according to one or more embodiments of the present disclosure.

FIG. 4A is a perspective view of a neck movement subsystem of the head and neck system for the patient simulator of FIGS. 1A-1E, according to one or more embodiments of the present disclosure.

FIG. 4B is an exploded perspective view of the neck movement subsystem of FIG. 4A, according to one or more embodiments of the present disclosure.

FIG. 4C is a perspective view of a neck linkage assembly of the neck movement subsystem of FIGS. 4A-4B, according to one or more embodiments of the present disclosure.

FIG. 4D is a front elevation view of the neck linkage assembly of FIG. 4C, according to one or more embodiments of the present disclosure.

FIG. 4E is a rear elevation view of the neck linkage assembly of FIG. 4C, according to one or more embodiments of the present disclosure.

FIG. 4F is a side elevation view of the neck linkage assembly of FIG. 4C, according to one or more embodiments of the present disclosure.

FIG. 4G is another side elevation view of the neck linkage assembly of FIG. 4C, according to one or more embodiments of the present disclosure.

FIG. 5A is a perspective view of an eyes subsystem of the head and neck system for the patient simulator of FIGS. 1A-1E, according to one or more embodiments of the present disclosure.

FIG. 5B is a perspective view of left and right eye assemblies and a blink movement assembly of the eyes subsystem of FIG. 5A, according to one or more embodiments of the present disclosure.

FIG. 5C is a perspective view of the blink movement assembly of FIG. 5B, according to one or more embodiments of the present disclosure.

FIG. 5D is a perspective view of the left and right eye assemblies of FIG. 5B, according to one or more embodiments of the present disclosure.

FIG. 5E is an exploded perspective view of a simulated eye of the right eye assembly of FIG. 5D, according to one or more embodiments of the present disclosure.

FIG. 5F is a perspective view of an eye movement subassembly of the right eye assembly of FIG. 5D operably coupled to an eye housing of the simulated eye of FIG. 5E, according to one or more embodiments of the present disclosure.

FIG. 5G is a partial cross-sectional side elevation view of the eye movement subassembly of FIG. 5F operably coupled to the eye housing of the simulated eye of FIG. 5E, according to one or more embodiments of the present disclosure.

FIG. 5H is a rear elevation view of the eye housing of the simulated eye of FIG. 5E, according to one or more embodiments of the present disclosure.

FIG. 6A is a perspective view of a brow movement subsystem of the head and neck system for the patient simulator of FIGS. 1A-1E, according to one or more embodiments of the present disclosure.

FIG. 6B is a side elevation view of the brow movement subsystem of FIG. 6A, according to one or more embodiments of the present disclosure.

FIG. 6C is a perspective view of a brow linkage assembly of the brow movement subsystem of FIGS. 6A-6B, according to one or more embodiments of the present disclosure.

FIG. 6D is a side elevation view of the brow linkage assembly of FIG. 6C, according to one or more embodiments of the present disclosure.

FIG. 7A is a perspective view of a lip movement subsystem of the head and neck system for the patient simulator of FIGS. 1A-1E, according to one or more embodiments of the present disclosure.

FIG. 7B is a front elevation view of the lip movement subsystem of FIG. 7A, according to one or more embodiments of the present disclosure.

FIG. 7C is a side elevation view of the lip movement subsystem of FIG. 7A, according to one or more embodiments of the present disclosure.

FIG. 8A is a perspective view of an airway subsystem of the head and neck system for the patient simulator of FIGS. 1A-1E, according to one or more embodiments of the present disclosure.

FIG. 8B is an exploded perspective view of the airway subsystem of FIG. 8A, according to one or more embodiments of the present disclosure.

FIG. 8C is a perspective view of a trachea assembly of the airway subsystem of FIGS. 8A-8B, according to one or more embodiments of the present disclosure.

FIG. 8D is a cross-sectional side elevation view of the trachea assembly of FIG. 8C, according to one or more embodiments of the present disclosure.

FIG. 8E is another side elevation view of the trachea assembly of FIG. 8C, according to one or more embodiments of the present disclosure.

FIG. 8F is a cross-sectional side elevation view of a simulated trachea insert of the airway subsystem of FIGS. 8A-8B, according to one or more embodiments of the present disclosure.

FIG. 8G is an exploded perspective view of the simulated trachea insert of FIG. 8F, according to one or more embodiments of the present disclosure.

FIG. 8H is a perspective view of a simulated vocal chords insert of the airway subsystem of FIGS. 8A-8B, according to one or more embodiments of the present disclosure.

FIG. 8I is a cross-sectional perspective view of the simulated vocal chords insert of FIG. 8H, according to one or more embodiments of the present disclosure.

FIG. 8J is a front elevation view of a laryngospasm assembly of the airway subsystem of FIGS. 8A-8B, according to one or more embodiments of the present disclosure.

FIG. 8K is a perspective view of a simulated nose and throat assembly of the airway subsystem of FIGS. 8A-8B, according to one or more embodiments of the present disclosure.

FIG. 8L is a cross-sectional side elevation view of the simulated nose and throat assembly of FIG. 8K, according to one or more embodiments of the present disclosure.

FIG. 9 diagrammatically illustrates a computing node for implementing one or more embodiments of the present disclosure.

### DETAILED DESCRIPTION

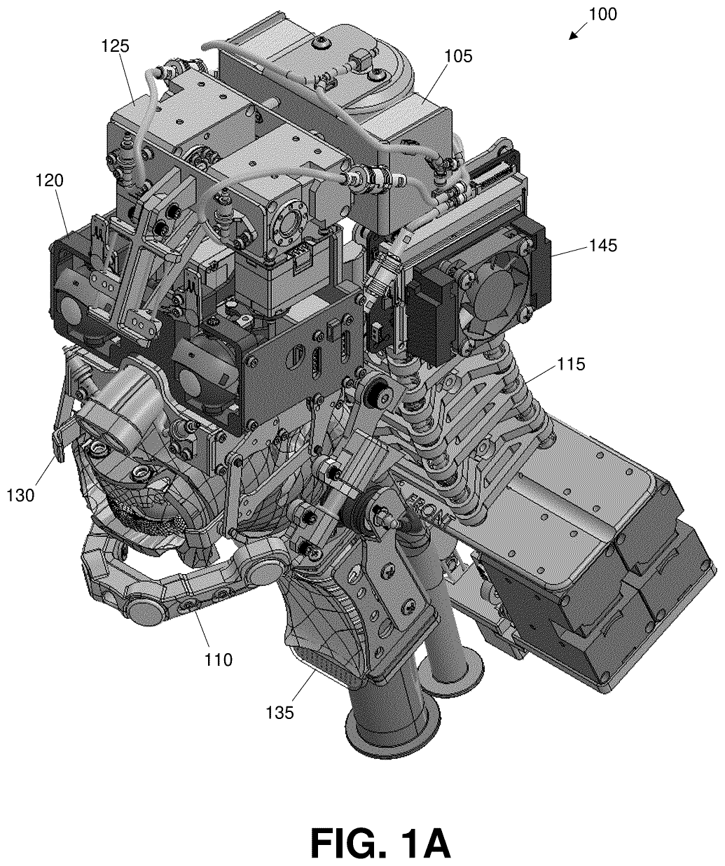

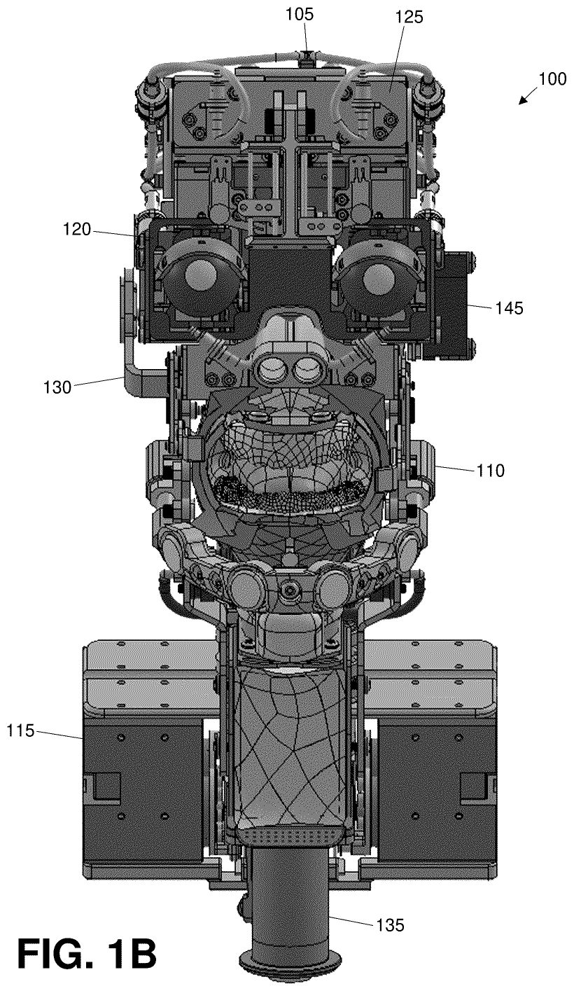

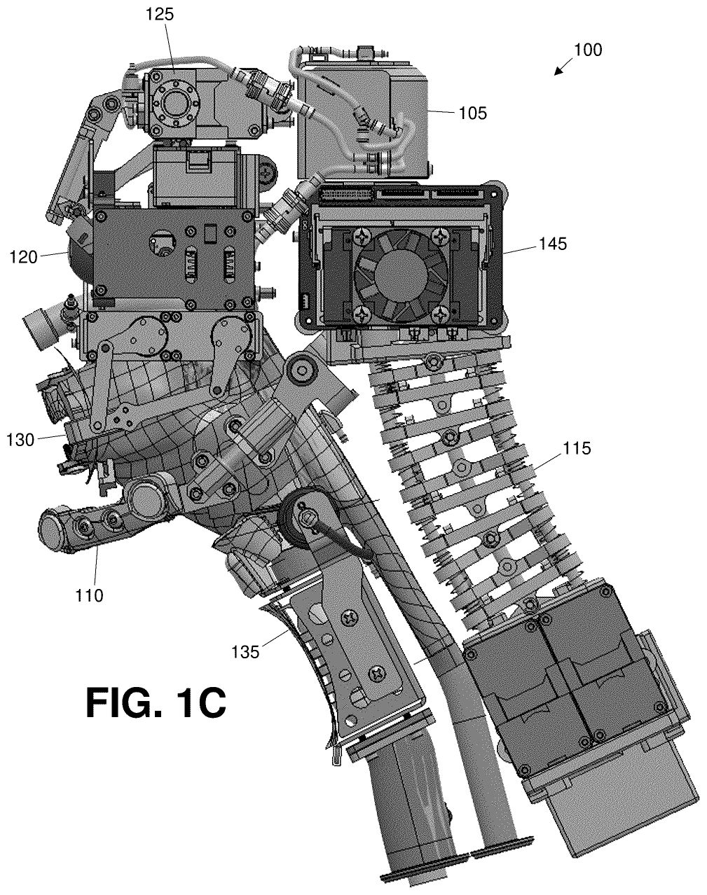

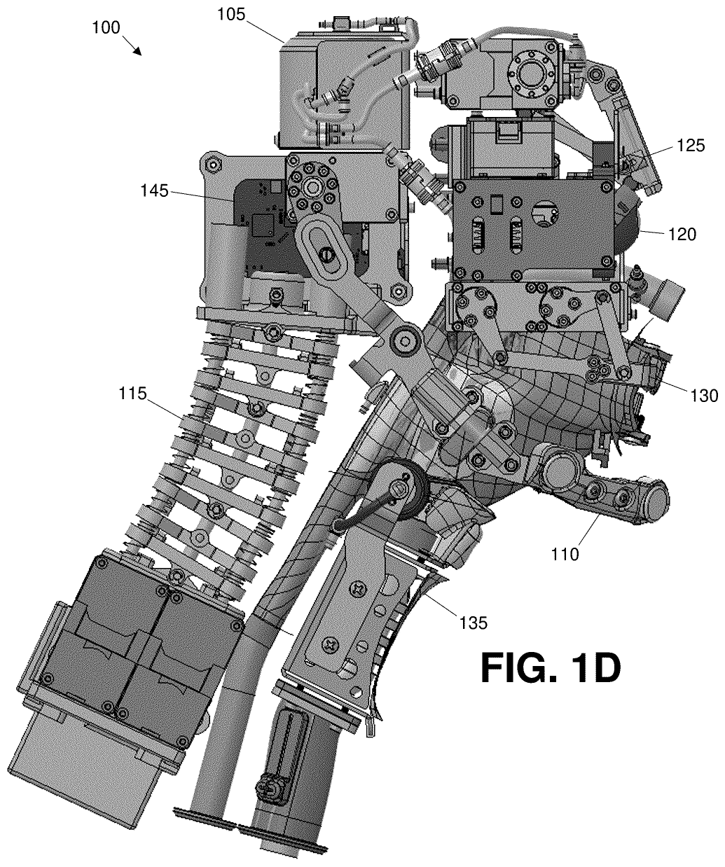

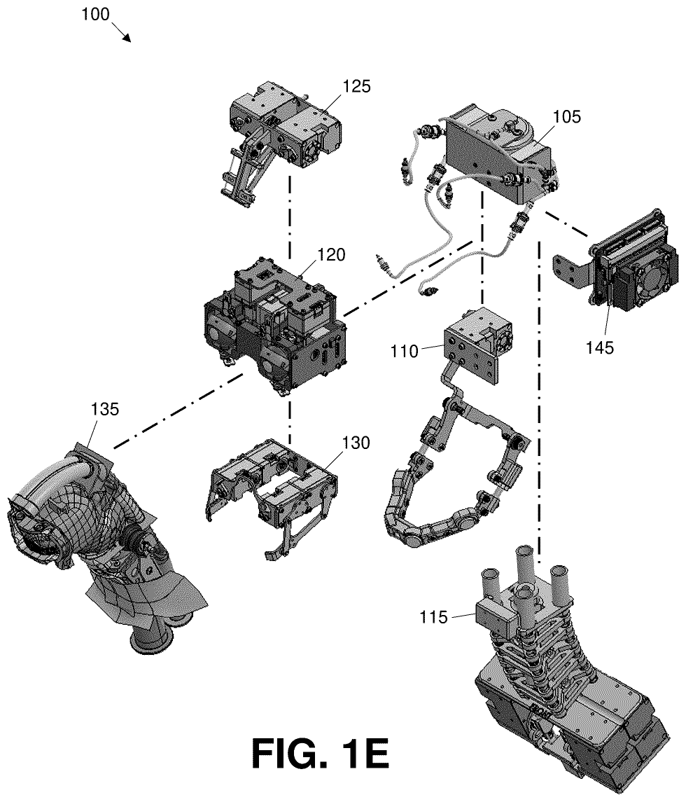

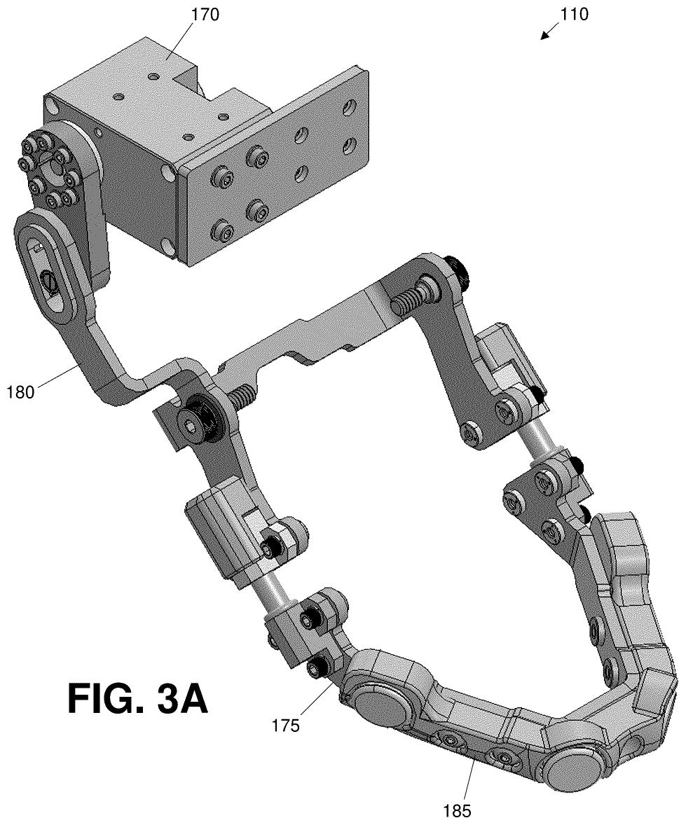

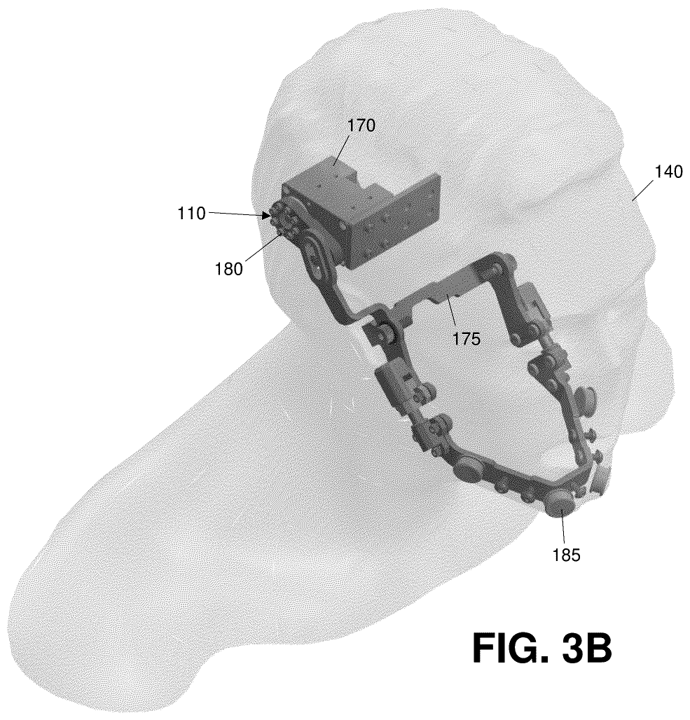

Referring to FIG. 1A, a perspective view of a head and neck system 100 for a patient simulator is illustrated, according to one or more embodiments of the present disclosure. The head and neck system 100 includes one or any combination of: a sweat and tears subsystem 105; a jaw movement subsystem 110; a neck movement subsystem 115; an eyes subsystem 120; a brow movement subsystem 125; a lip movement subsystem 130; an airway subsystem 135; and one or more simulated skin layers 140 (shown in FIG. 3B) adapted to cover the head and neck system 100 for the patient simulator. The head and neck system 100 also includes one or more controllers 145 adapted to control the various subsystems, as will be discussed in further detail below.

In one or more embodiments, the sweat and tears subsystem 105, the jaw movement subsystem 110, the eyes subsystem 120, the brow movement subsystem 125, the lip movement subsystem 130, the airway subsystem 135, and the one or more simulated skin layers 140, alone or in any combination, are, include, or are part of a “simulated head” of the head and neck system 100. In one or more embodiments, the neck movement subsystem 115, the airway subsystem 135, and the one or more simulated skin layers 140, alone or in any combination, are, include, or are part of a “simulated neck” of the head and neck system 100. In one or more embodiments, the jaw movement subsystem 110, the lip movement subsystem 130, the airway subsystem 135, and the one or more simulated skin layers 140, alone or in any combination, are, include, or are part of a “simulated nasopharynx” and/or a “simulated mouth” of the “simulated head” of the head and neck system 100. In one or more embodiments, the sweat and tears subsystem 105, the eyes subsystem 120, the brow movement subsystem 125, and the one or more simulated skin layers 140, alone or in any combination, are, include, or are part of a “simulated periorbital area” of the “simulated head” of the head and neck system 100.

Referring to FIG. 1B, with continuing reference to FIG. 1A, a front elevation view of the head and neck system 100 for the patient simulator is illustrated, according to one or more embodiments of the present disclosure.

Referring to FIG. 1C, with continuing reference to FIG. 1A, a side elevation view of the head and neck system 100 for the patient simulator is illustrated, according to one or more embodiments of the present disclosure.

Referring to FIG. 1D, with continuing reference to FIG. 1A, another side elevation view of the head and neck system 100 for the patient simulator is illustrated, according to one or more embodiments of the present disclosure.

Referring to FIG. 1E, with continuing reference to FIG. 1A, an exploded perspective view of the head and neck system 100 for the patient simulator is illustrated, according to one or more embodiments of the present disclosure.

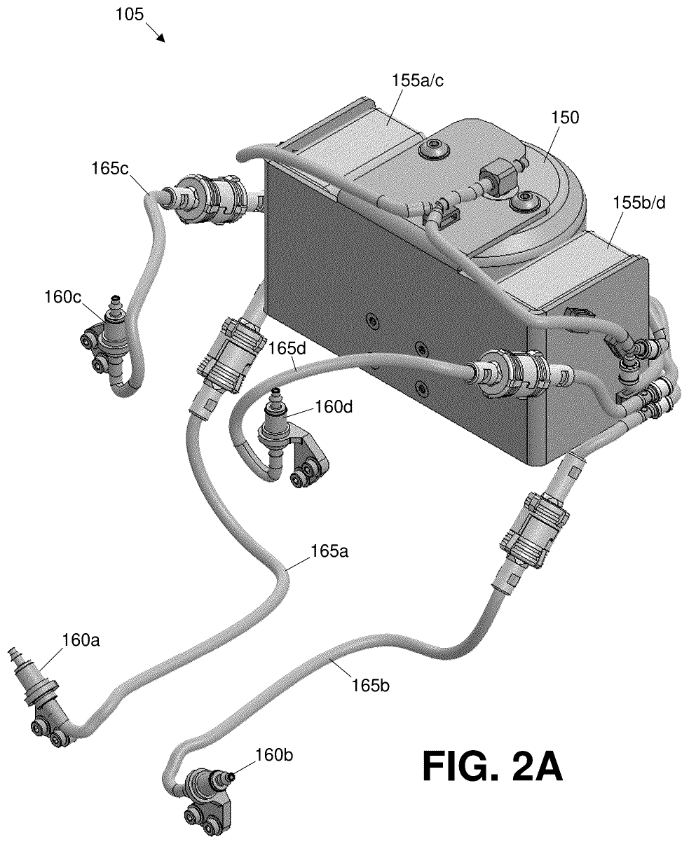

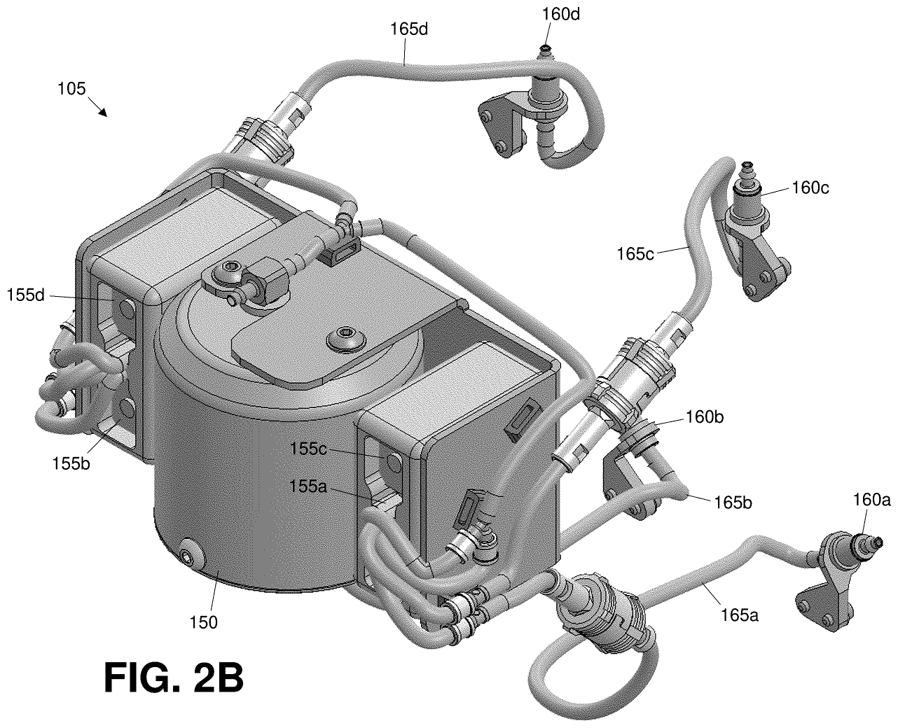

Referring to FIG. 2A, with continuing reference to FIGS. 1A-1E, a perspective view of the sweat and tears subsystem 105 of the head and neck system 100 for the patient simulator is illustrated, according to one or more embodiments of the present disclosure. The sweat and tears subsystem 105 includes a sweat and tears reservoir 150 and a plurality of (e.g., peristaltic) pumps 155 controllable by the one or more controllers 145 to operate the sweat and tears subsystem 105, thereby communicating fluid from the sweat and tears reservoir 150 to one or more fittings 160 operably coupled to corresponding artificial pore(s) formed in the one or more simulated skin layers 140 covering the head and neck system 100 for the patient simulator. For example, a first (e.g., peristaltic) pump 155a of the plurality of pumps 155 may be adapted to communicate fluid via first tubing 165a from the sweat and tears reservoir 150 to a first fitting 160a operably coupled to a first right-side artificial pore (to simulate life-like right-side tears) formed in the one or more simulated skin layers 140 covering the head and neck system 100 for the patient simulator. For another example, a second (e.g., peristaltic) pump 155b of the plurality of pumps 155 may be adapted to communicate fluid via second tubing 165b from the sweat and tears reservoir 150 to a second fitting 160b operably coupled to a first left-side artificial pore (to simulate life-like left-side tears) formed in the one or more simulated skin layers 140 covering the head and neck system 100 for the patient simulator. For yet another example, a third (e.g., peristaltic) pump 155c of the plurality of pumps 155 may be adapted to communicate fluid via third tubing 165c from the sweat and tears reservoir 150 to a third fitting 160c operably coupled to a second right-side artificial pore (to simulate life-like right-side brow sweat) formed in the one or more simulated skin layers 140 covering the head and neck system 100 for the patient simulator. For a final example, a fourth (e.g., peristaltic) pump 155d of the plurality of pumps 155 may be adapted to communicate fluid via fourth tubing 165d from the sweat and tears reservoir 150 to a fourth fitting 160d operably coupled to a second left-side artificial pore (to simulate life-like left-side brow sweat) formed in the one or more simulated skin layers 140 covering the head and neck system 100 for the patient simulator.

Referring to FIG. 2B, with continuing reference to FIGS. 2A, another perspective view of the sweat and tears subsystem 105 is illustrated, according to one or more embodiments of the present disclosure.

Referring to FIG. 3A, with continuing reference to FIGS. 1A-1E, a perspective view of the jaw movement subsystem 110 of the head and neck system 100 for the patient simulator is illustrated, according to one or more embodiments of the present disclosure. The jaw movement subsystem 110 includes a jaw actuator 170, a jaw frame assembly 175, and a jaw linkage assembly 180. The jaw actuator 170 is operably coupled to the jaw frame assembly 175 via the jaw linkage assembly 180, and is controllable by the one or more controllers 145 to operate the jaw movement subsystem 110. FIG. 3A further illustrates a “jaw interface” 185 connected to the jaw frame, which “jaw interface” 185 is, includes, or is part of (e.g., integrally formed with) the one or more simulated skin layers 140 covering the head and neck system 100.

Referring to FIG. 3B, with continuing reference to FIG. 3A, a perspective view of the jaw movement subsystem 110 interfacing (via the “jaw interface” 185) with the one or more simulated skin layers 140 covering the head and neck system 100 for the patient simulator is illustrated, according to one or more embodiments of the present disclosure.

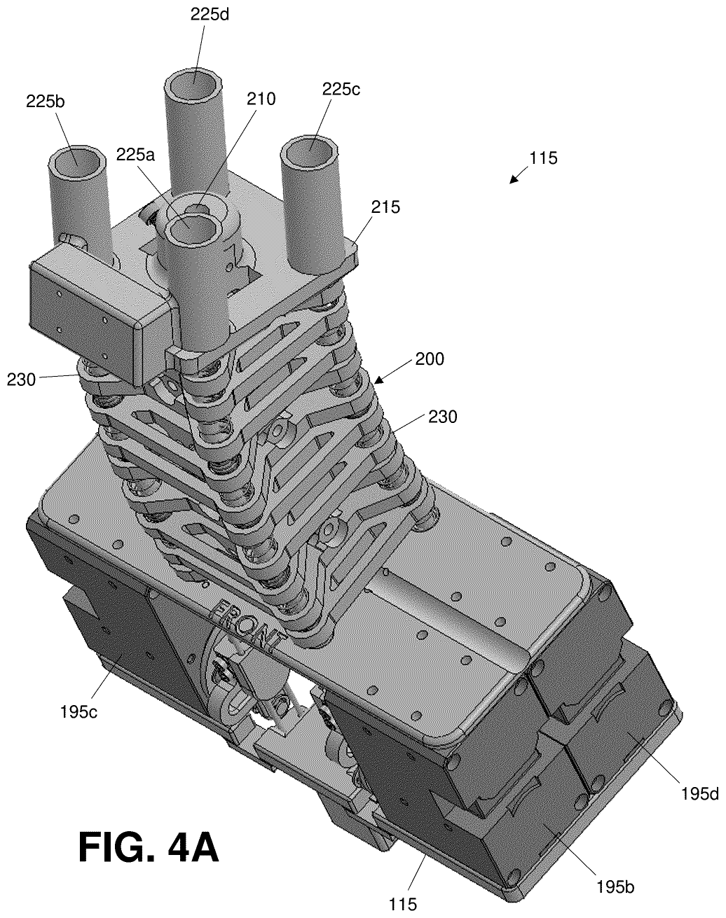

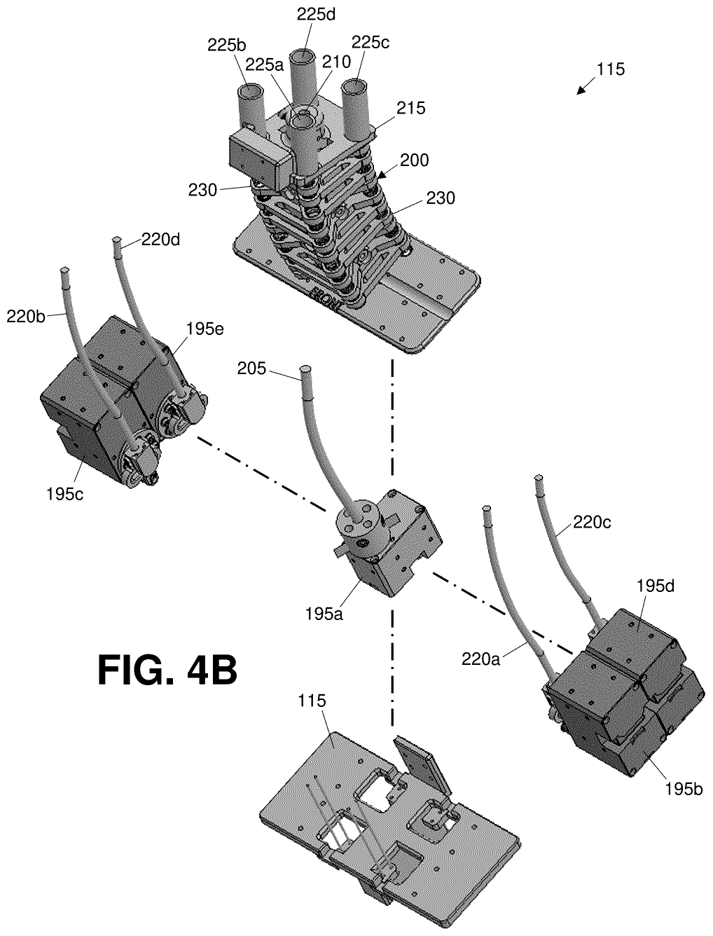

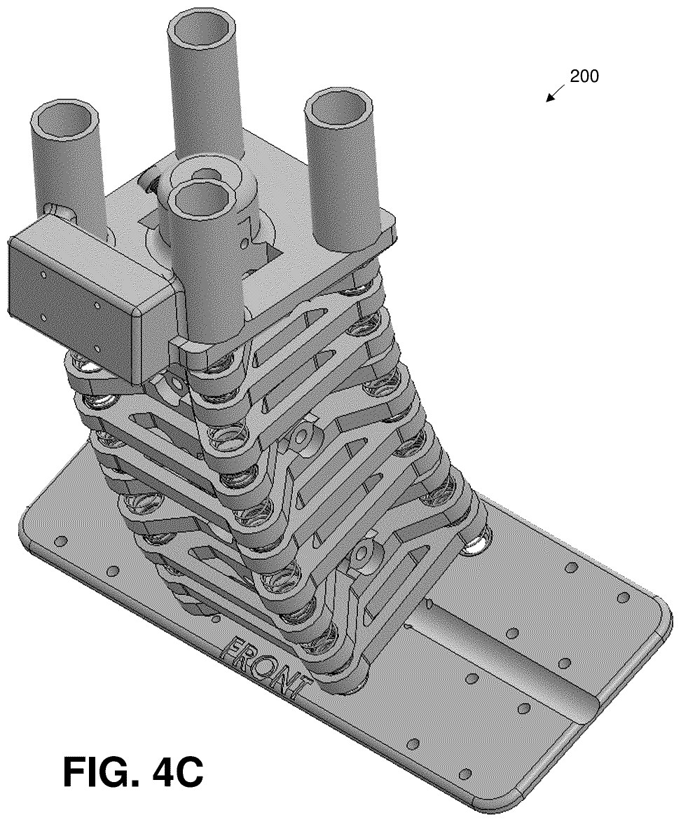

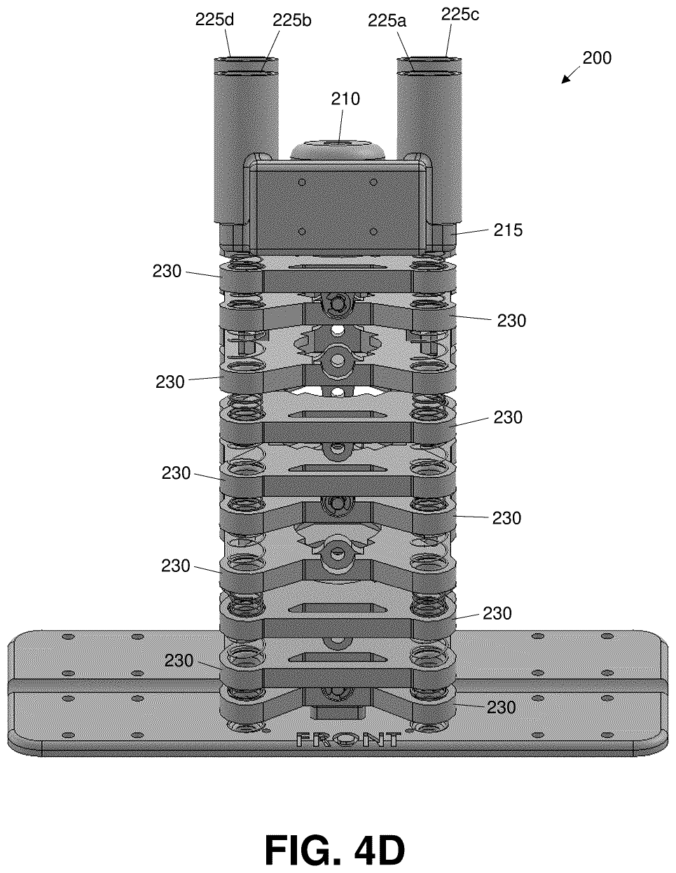

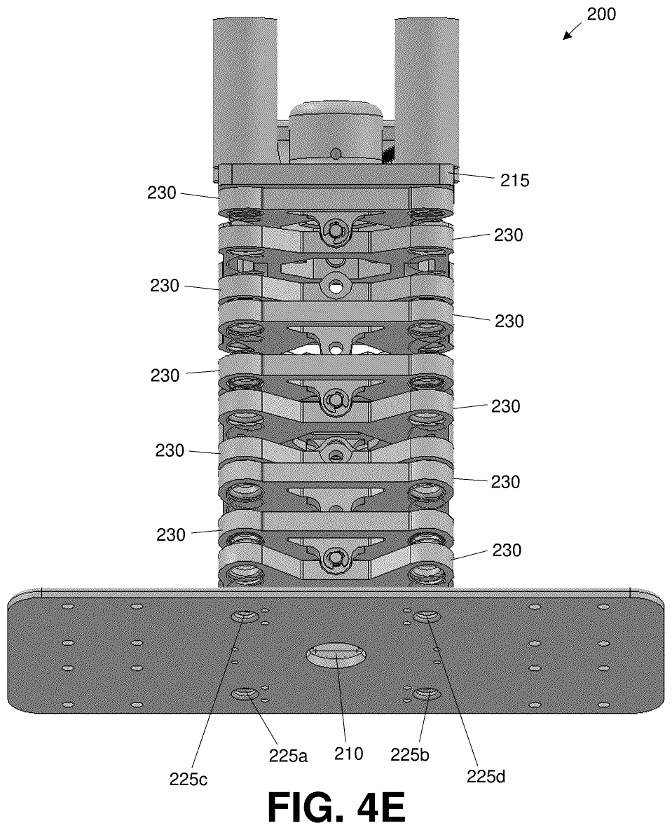

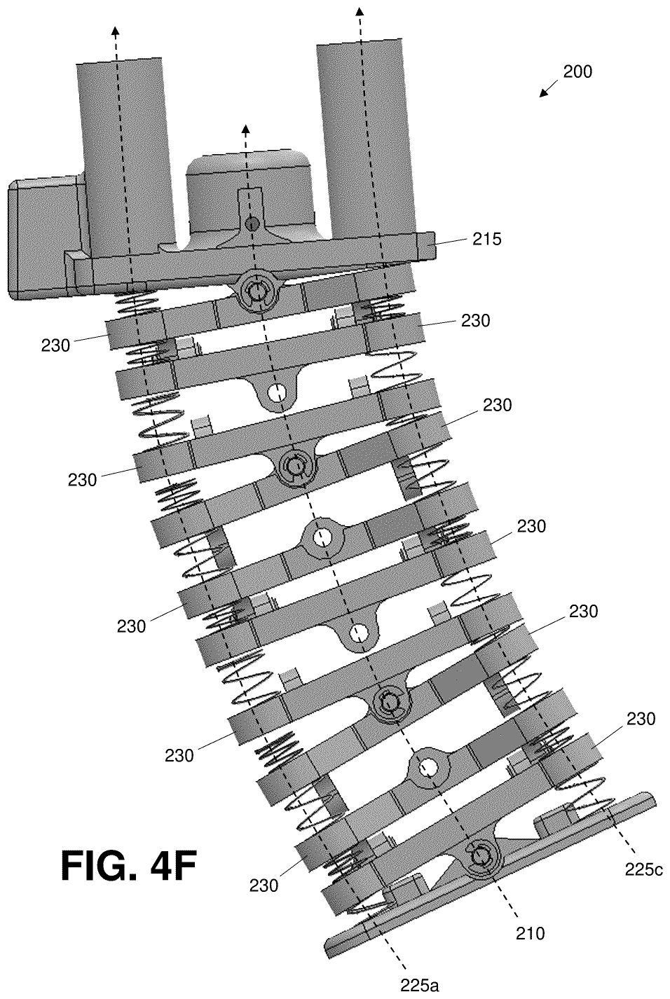

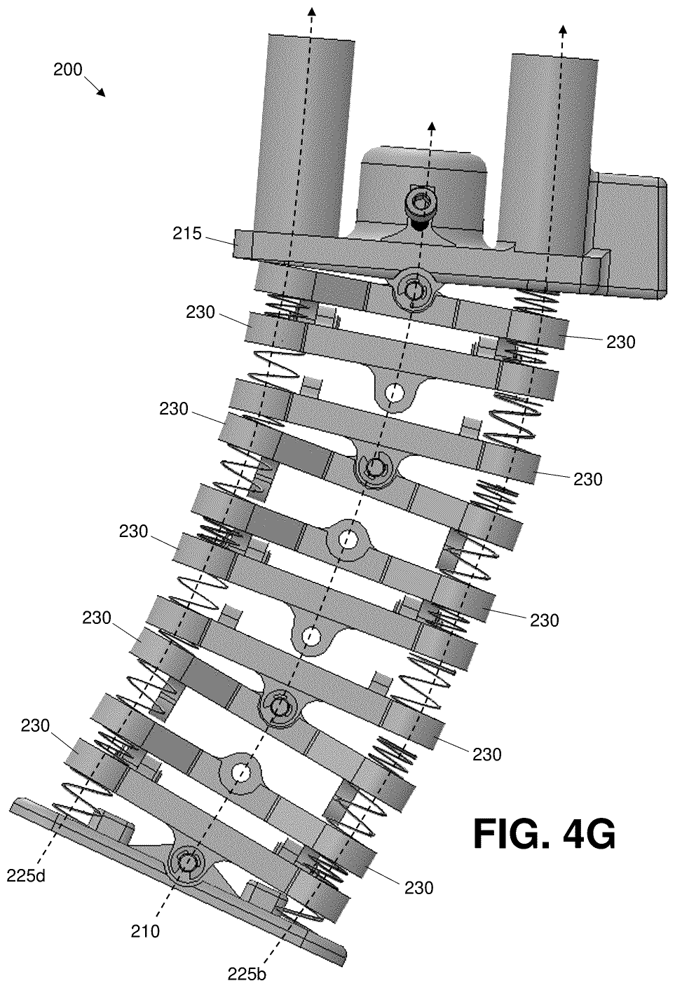

Referring to FIG. 4A, with continuing reference to FIGS. 1A-1E, a perspective view of the neck movement subsystem 115 (also referred as a “high degree-of-freedom” neck movement subsystem) of the head and neck system 100 for the patient simulator is illustrated, according to one or more embodiments of the present disclosure. In one or more embodiments, the “high degree-of-freedom” neck movement subsystem 115 emulates the intricate motions of a human neck, providing a high level of realism. The neck movement subsystem 115 includes a base plate 190, a plurality of neck actuators 195, and a neck linkage assembly 200. The plurality of neck actuators 195 includes a central rotational actuator 195a controllable by the one or more controllers 145 to rotate the neck linkage assembly 200 via a corresponding rotational actuation rod 205 (e.g., a flexible yaw shaft) extending from the central rotational actuator 195a, through a central passageway 210 of the neck linkage assembly 200, and being operably coupled to a top plate 215 of the neck linkage assembly 200. The plurality of neck actuators 195 further includes a plurality (e.g., four) of peripheral linear actuators 195b-e controllable by the one or more controllers 145 to move the neck linkage assembly 200 via corresponding linear actuation rods 220a-d (e.g., flexible pitch and roll shafts) extending from the plurality of peripheral linear actuators 195b-e, through corresponding peripheral passageways 225a-d of the neck linkage assembly 200, and being operably coupled to the top plate 215 of the neck linkage assembly 200.

Similarly to a human cervical spine, the neck linkage assembly 200 includes a segmented linear series of links 230 that operably couple the head and neck system 100 to a simulated torso of the patient simulator, allowing for life-like head and neck movements. As a result, the neck linkage assembly 200 provides passive motion closely resembling the flexibility of the human cervical spine (e.g., by utilizing between 14 and 21 passive degrees-of-freedom to achieve this range of motion). The plurality of neck actuators 195 are controllable by the one or more controllers 145 to actively manipulate the neck linkage assembly 200, enabling roll, pitch, and yaw motions. These five (5) active degrees-of-freedom, in combination with the segmented linear links 230 of the neck linkage assembly 200, facilitate smooth, human-like neck movement trajectories. The plurality of neck actuators 195 are each independently controllable by the one or more controllers 145 to permit a broad range of neck positions, and precise (e.g., closed-loop) position feedback mechanisms guarantee meticulous control over neck position adjustments.

Referring to FIG. 4B, with continuing reference to FIG. 4A, an exploded perspective view of the neck movement subsystem 115 is illustrated, according to one or more embodiments of the present disclosure.

Referring to FIG. 4C, with continuing reference to FIGS. 4A-4B, a perspective view of the neck linkage assembly 200 of the neck movement subsystem 115 is illustrated, according to one or more embodiments of the present disclosure.

Referring to FIG. 4D, with continuing reference to FIG. 4C, a front elevation view of the neck linkage assembly 200 is illustrated, according to one or more embodiments of the present disclosure.

Referring to FIG. 4E, with continuing reference to FIG. 4C, a rear elevation view of the neck linkage assembly 200 is illustrated, according to one or more embodiments of the present disclosure.

Referring to FIG. 4F, with continuing reference to FIG. 4C, a side elevation view of the neck linkage assembly 200 is illustrated, according to one or more embodiments of the present disclosure.

Referring to FIG. 4G, with continuing reference to FIG. 4C, another side elevation view of the neck linkage assembly 200 is illustrated, according to one or more embodiments of the present disclosure.

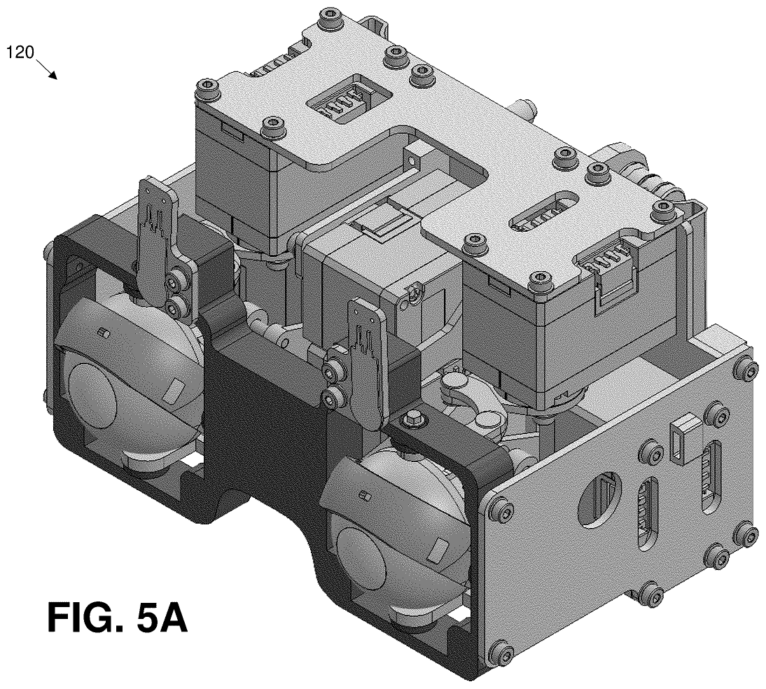

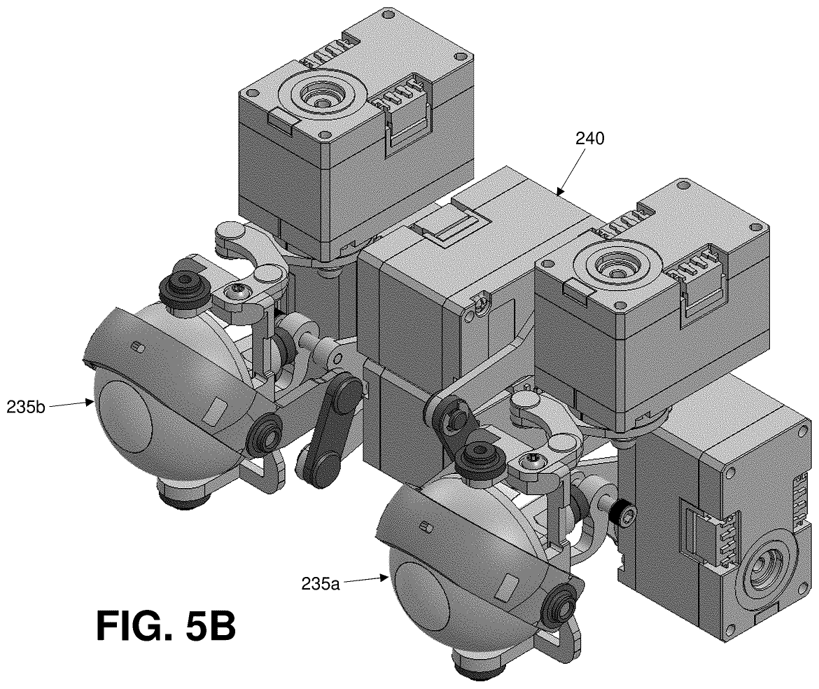

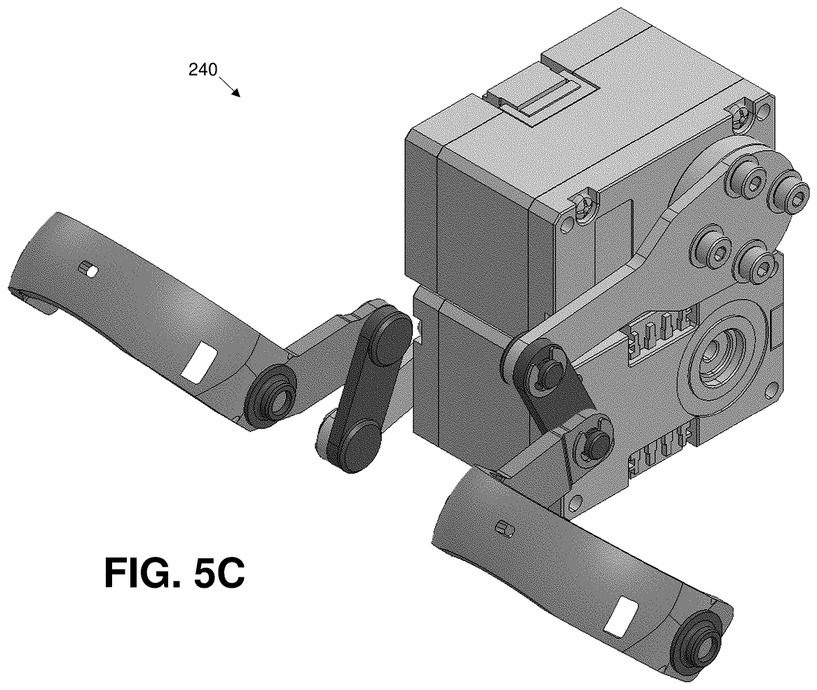

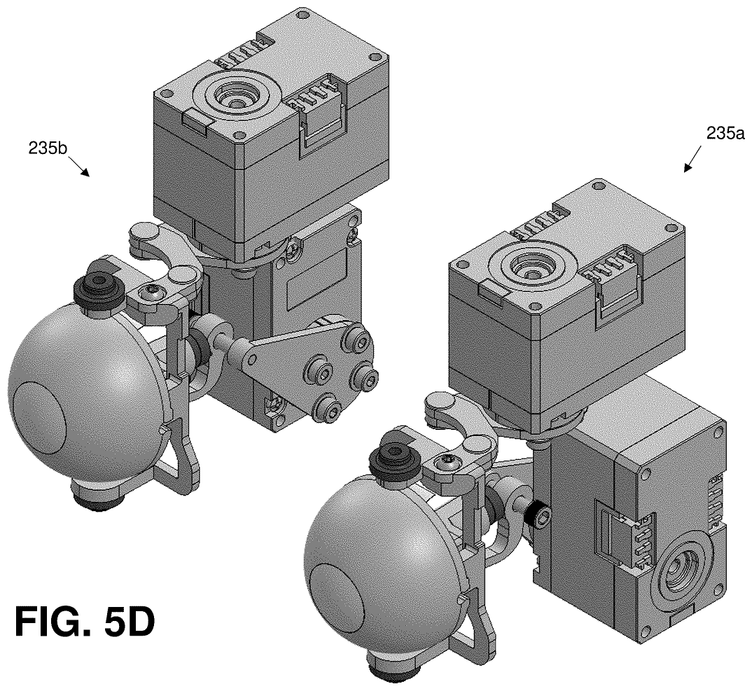

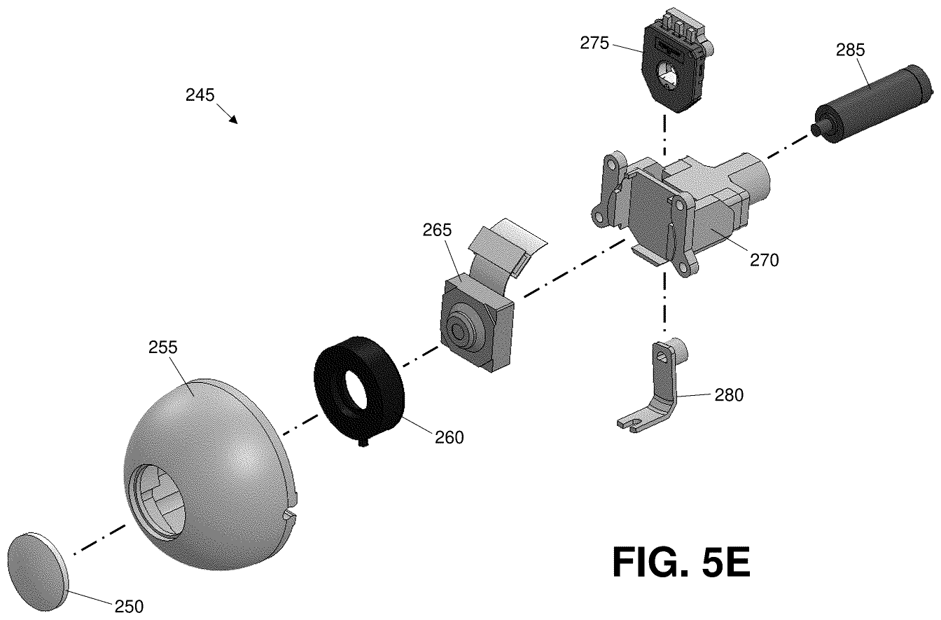

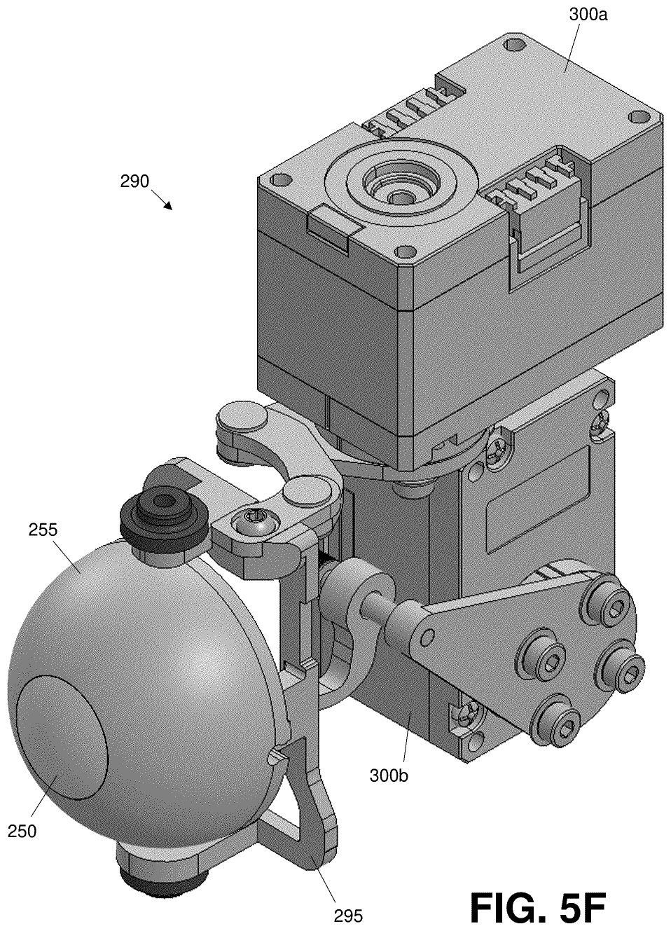

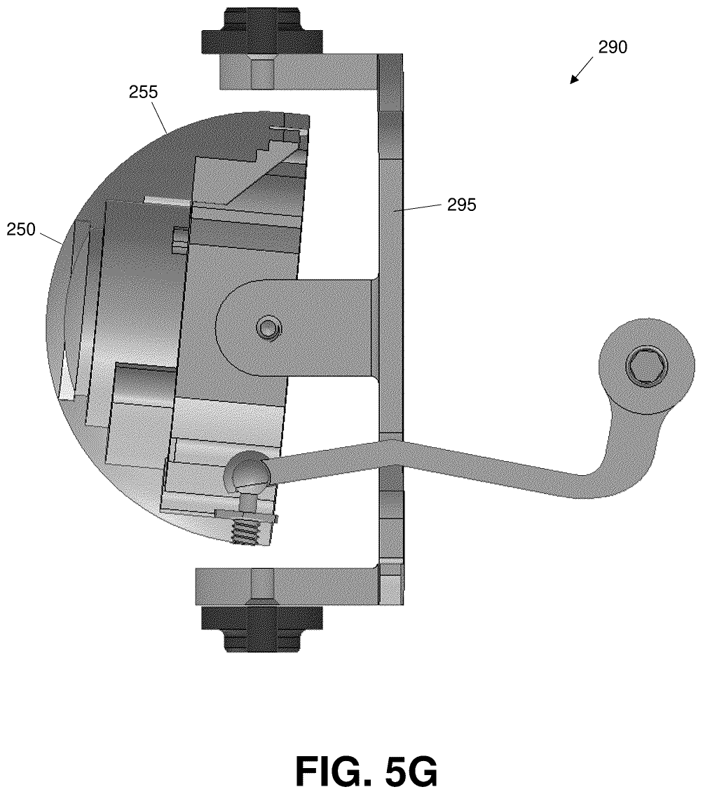

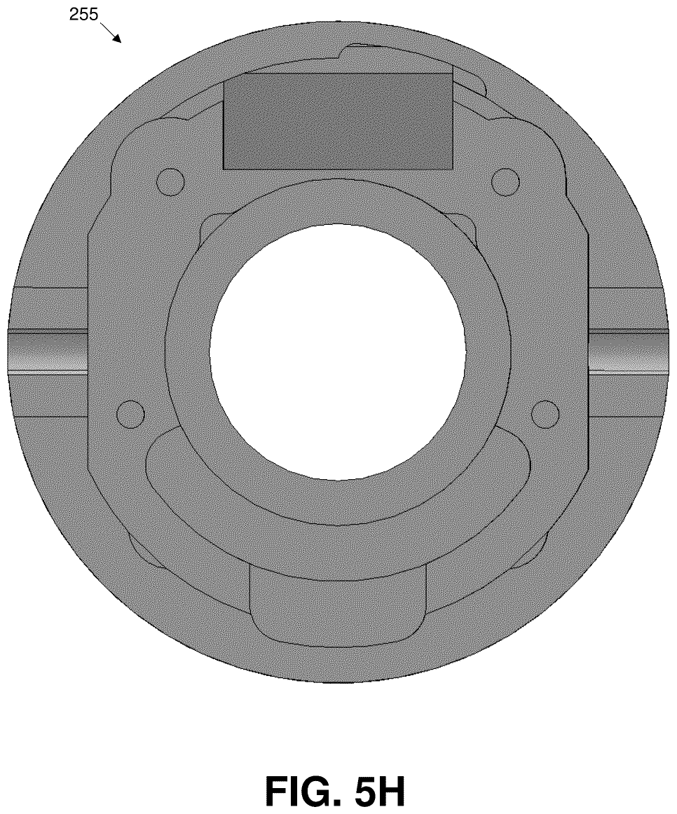

Referring to FIG. 5A, with continuing reference to FIGS. 1A-1E, a perspective view of the eyes subsystem 120 (also referred to as a “camera eyes” subsystem) of the head and neck system 100 for the patient simulator is illustrated, according to one or more embodiments of the present disclosure. In one or more embodiments, the “camera eyes” subsystem 120 improves visual perception by the patent simulator, replicating the capabilities of human vision while also facilitating advanced functionality.

Referring to FIG. 5B, with continuing reference to FIG. 5A, a perspective view of left and right eye assemblies 235a-b and a blink movement assembly 240 of the eyes subsystem 120 is illustrated, according to one or more embodiments of the present disclosure.

Referring to FIG. 5C, with continuing reference to FIG. 5B, a perspective view of the blink movement assembly 240 is illustrated, according to one or more embodiments of the present disclosure.

Referring to FIG. 5D, with continuing reference to FIG. 5B, a perspective view of the left and right eye assemblies 235a-b is illustrated, according to one or more embodiments of the present disclosure.

Referring to FIG. 5E, with continuing reference to FIG. 5D, an exploded perspective view of a simulated eye 245 of the right eye assembly 235b is illustrated, according to one or more embodiments of the present disclosure. The simulated eye 245 includes (from left-to-right) a simulated cornea 250, an eye housing 255, a simulated iris 260, an eye camera 265, a camera mount 270, an iris position sensor 275, an iris actuation arm 280, and an iris actuator 285. The simulated iris 260 dynamically adjusts size in response to ambient light levels (e.g., detected by the eye camera 265) to mimic human pupil behavior; this adaptive mechanism, located at the approximate position of a real-life human pupil, emulates the natural dilation and constriction of a human iris. The iris actuator 285 is controllable by the one or more controllers 145 to enable precise control over the size of the simulated iris 260, while precise (e.g., closed-loop) feedback control (via the iris position sensor 275) ensures accurate control over iris size adjustments (enabling the simulated eye 245 to match typical human iris sizes). The eye camera 265 is located proximate the position of a real-life human pupil, allowing the patient simulator to capture and process visual information in real-time. The eye camera 265 communicates with the one or more controllers 145, which may include onboard GPU processing to enable a wide range of visual tasks, including but not limited to face tracking and identification, hand tracking (for medical accommodation assessments), and object tracking and identification.

Referring to FIG. 5F, with continuing reference to FIG. 5D, a perspective view of an eye movement subassembly 290 of the right eye assembly 235b is illustrated, which eye movement subassembly 290 is operably coupled to the eye housing 255 of the simulated eye 245 (shown in FIG. 5E), according to one or more embodiments of the present disclosure. The eye movement subassembly 290 includes a two (2) degree-of-freedom gimbal 295 driven by first and second eye actuators 300a-b, which first and second eye actuators 300a-b are independently controllable by the one or more controllers 145 to impart vertical and horizontal movement to the simulated eye 245, thereby replicating human eye movement. More particularly, the first eye actuator 300a governs horizontal movement and the second eye actuator 300b governs vertical movement. The first and second eye actuators 300a-b operate independently to enable precise positioning in two (2) degrees-of-freedom, while precise (e.g., closed-loop) feedback mechanisms ensure accurate control over eye position adjustments.

Referring to FIG. 5G, with continuing reference to FIG. 5F, a partial cross-sectional side elevation view of the eye movement subassembly 290 is illustrated, which eye movement subassembly 290 is operably coupled to the eye housing 255 of the simulated eye 245 (shown in FIG. 5E), according to one or more embodiments of the present disclosure.

Referring to FIG. 5H, with continuing reference to FIG. 5E, a rear elevation view of the eye housing 255 of the simulated eye 245 is illustrated, according to one or more embodiments of the present disclosure.

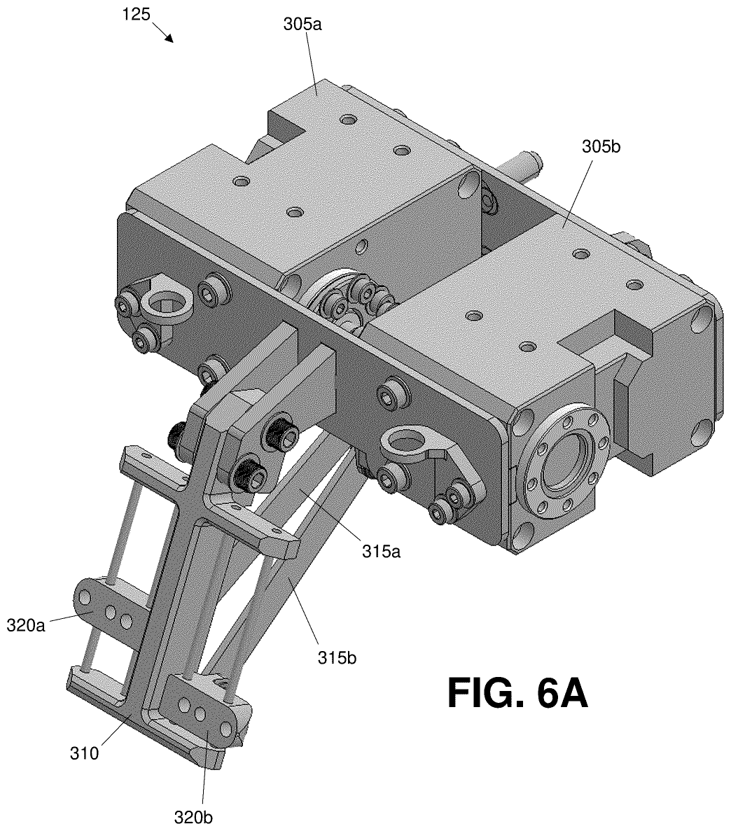

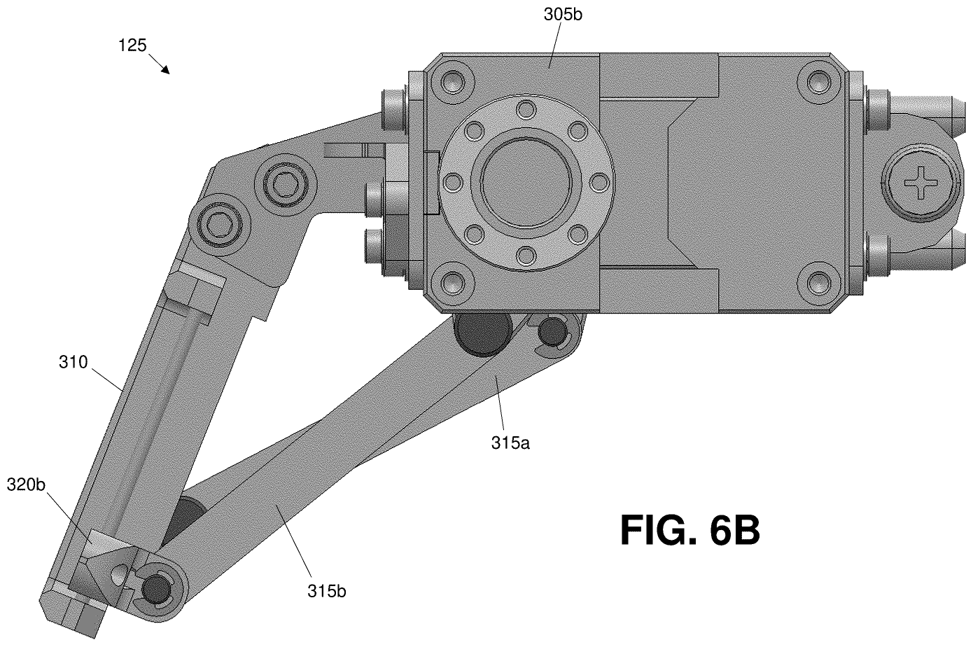

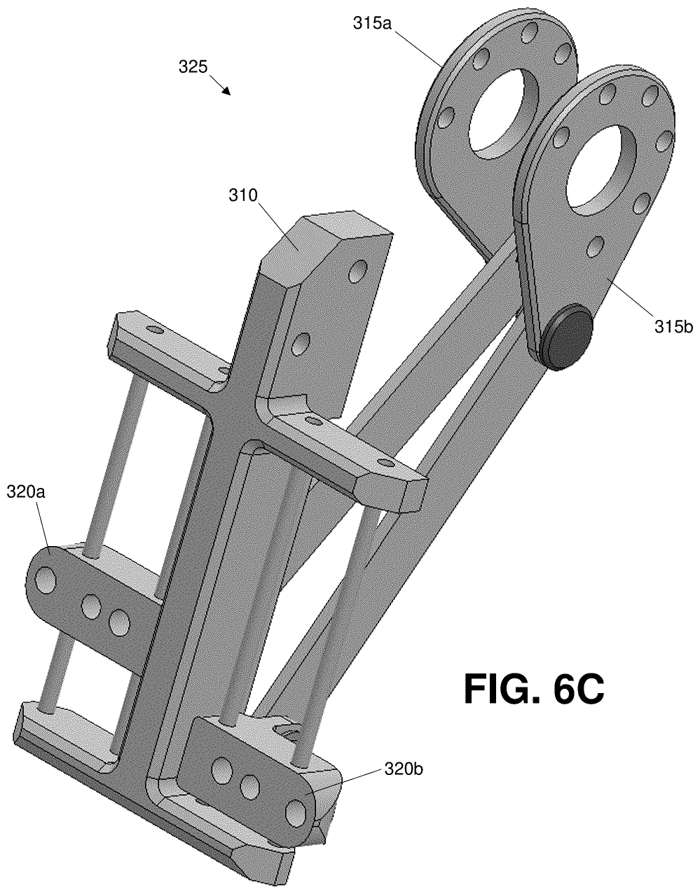

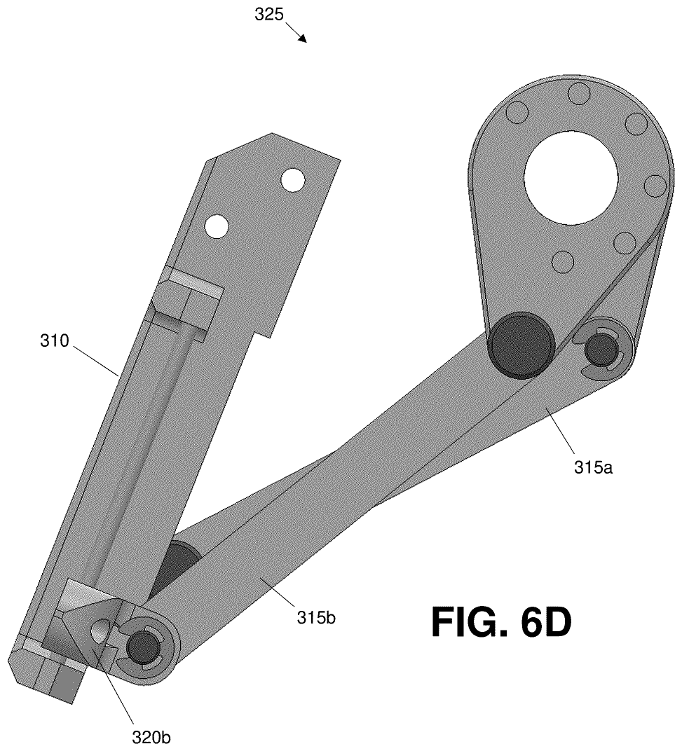

Referring to FIG. 6A, with continuing reference to FIGS. 1A-1E, a perspective view of the brow movement subsystem 125 of the head and neck system 100 for the patient simulator is illustrated, according to one or more embodiments of the present disclosure. The brow movement subsystem 125 includes first and second brow actuators 305a-b, a brow frame assembly 310, and first and second brow linkages 315a-b. The first brow actuator 305a is operably coupled via the first brow linkage 315a to a first (e.g., right-side) simulated brow 320a linearly movable along a first portion of the brow frame assembly 310. Similarly, the second brow actuator 305b is operably coupled via the second brow linkage 315b to a second (e.g., left-side) simulated brow 320b linearly movable along a second portion of the brow frame assembly 310. The first and second brow actuators 305a-b are independently controllable by the one or more controllers 145 to move the first and second simulated brows 320a-b linearly along the brow frame assembly 310, which first and second simulated brows 320a-b are operably coupled to corresponding brow regions of the one or more simulated skin layers 140 covering the head and neck system 100 for the patient simulator, thereby simulated realistic human brow movement.

Referring to FIG. 6B, with continuing reference to FIG. 6A, a side elevation view of the brow movement subsystem 125 is illustrated, according to one or more embodiments of the present disclosure.

Referring to FIG. 6C, with continuing reference to FIGS. 6A-6B, a perspective view of a brow linkage assembly 325 of the brow movement subsystem 125 is illustrated, which brow linkage assembly 325 includes the first and second portions of the brow frame assembly 310 together with the corresponding first and second brow linkages 315a-b, according to one or more embodiments of the present disclosure.

Referring to FIG. 6D, with continuing reference to FIG. 6C, a side elevation view of the brow linkage assembly 325 is illustrated, according to one or more embodiments of the present disclosure.

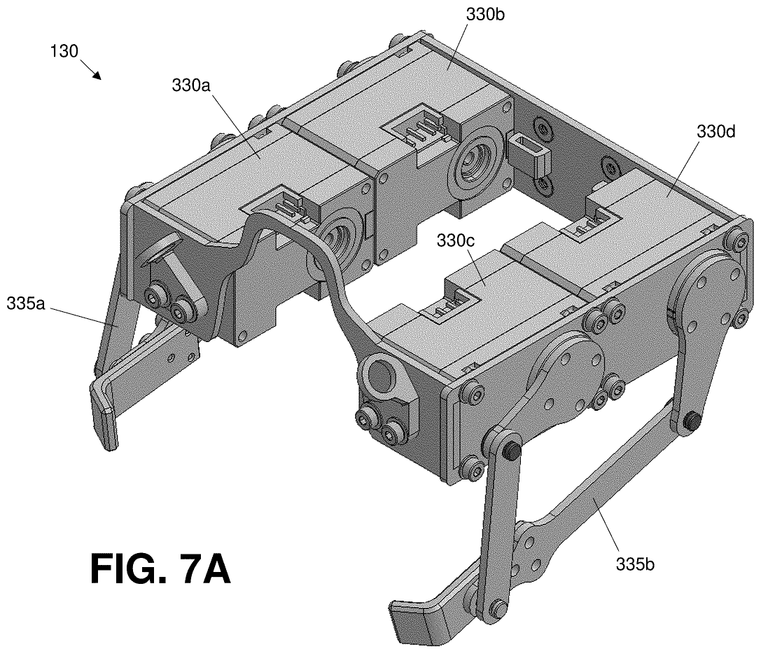

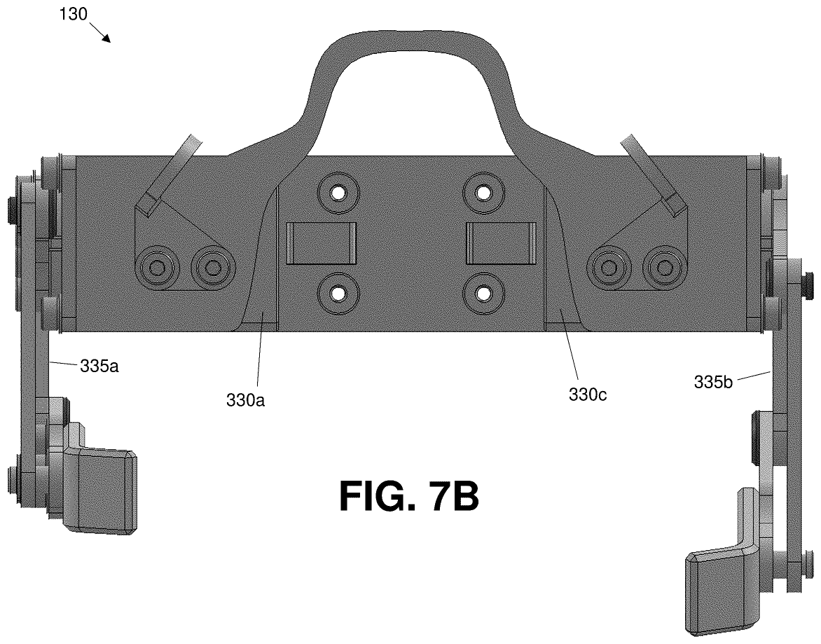

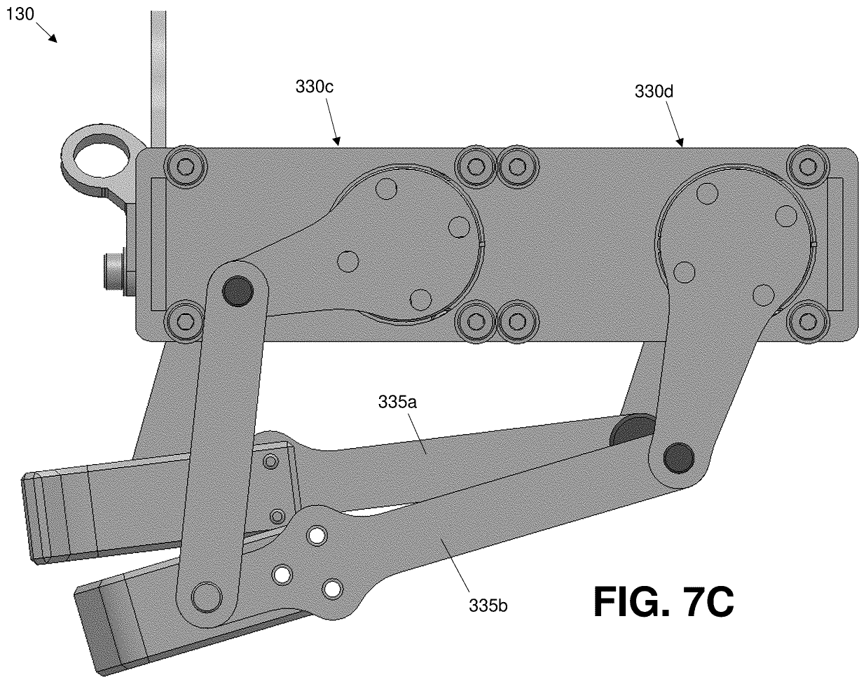

Referring to FIG. 7A, with continuing reference to FIGS. 1A-1E, a perspective view of the lip movement subsystem 130 of the head and neck system 100 for the patient simulator is illustrated, according to one or more embodiments of the present disclosure. The lip movement subsystem 130 includes a plurality of lip actuators 330 and a plurality of lip linkage assemblies 335. For example, first and second lip actuators 330a-b of the plurality of lip actuators 330 may be operably coupled to a first (e.g., right-side) lip linkage assembly 335a of the plurality of lip linkage assemblies 335. The first and second lip actuators 330a-b are independently controllable by the one or more controllers 145 to move the first lip linkage 335a, which first lip linkage 335a is operably coupled to a corresponding lip region (e.g., upper right lip region) of the one or more simulated skin layers 140 covering the head and neck system 100 for the patient simulator. For another example, third and fourth lip actuators 330c-d of the plurality of lip actuators 330 may be operably coupled to a second (e.g., left-side) lip linkage assembly 335b of the plurality of lip linkage assemblies 335. The third and fourth lip actuators 330c-d are independently controllable by the one or more controllers 145 to move the second lip linkage 335b, which second lip linkage 335b is operably coupled to a corresponding lip region (e.g., upper left lip region) of the one or more simulated skin layers 140 covering the head and neck system 100 for the patient simulator. As a result, the plurality of lip actuators 330 are independently controllable by the one or more controllers 145 to simulate realistic human lip movement.

Referring to FIG. 7B, with continuing reference to FIG. 7A, a front elevation view of the lip movement subsystem 130 is illustrated, according to one or more embodiments of the present disclosure.

Referring to FIG. 7C, with continuing reference to FIG. 7A, a side elevation view of the lip movement subsystem 130 is illustrated, according to one or more embodiments of the present disclosure.

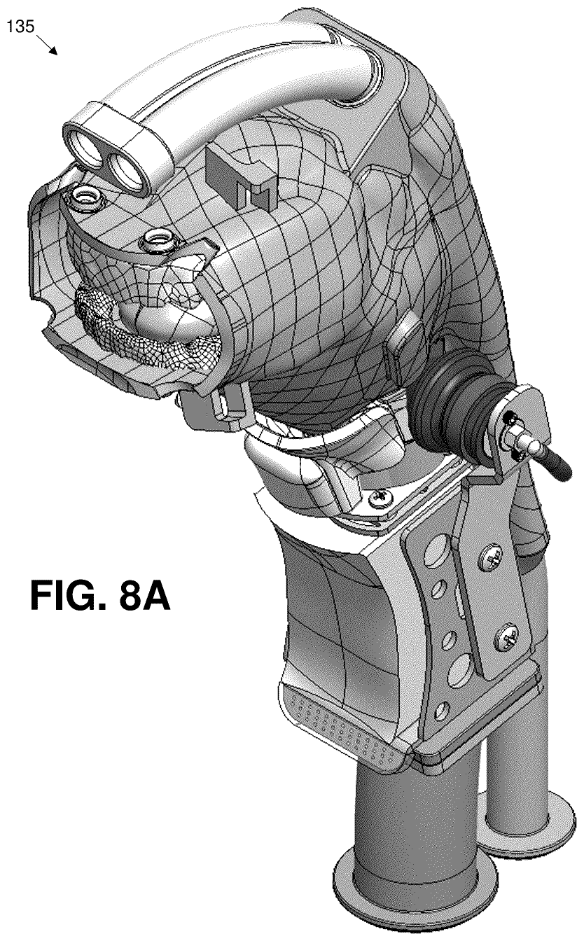

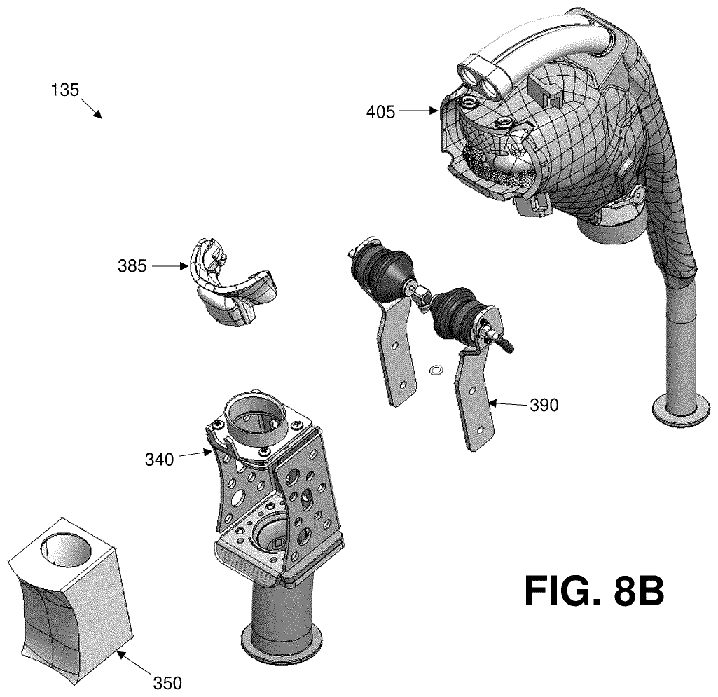

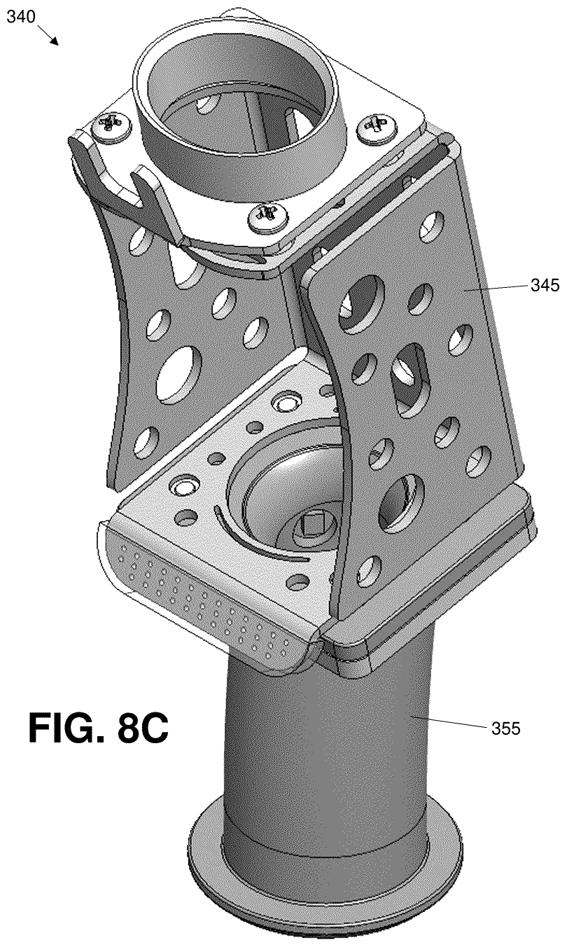

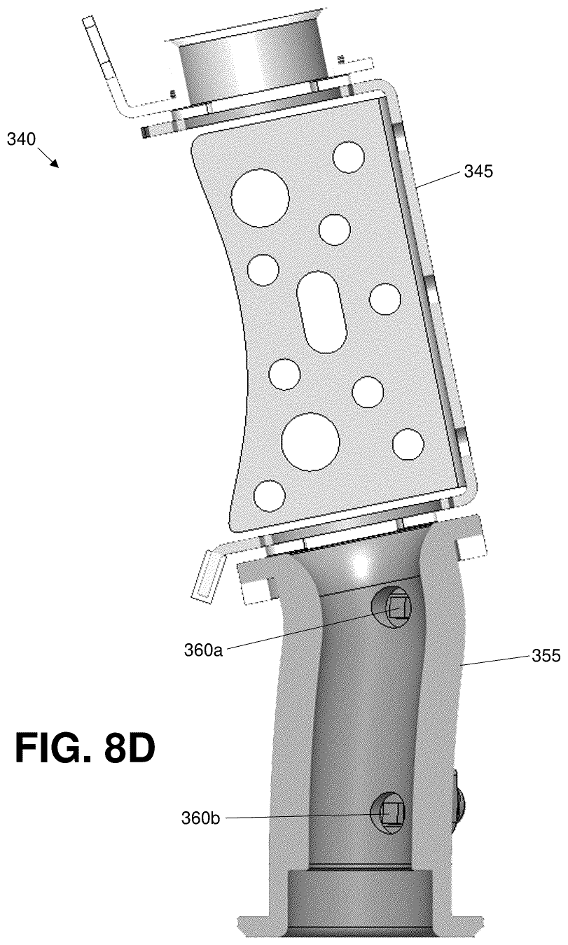

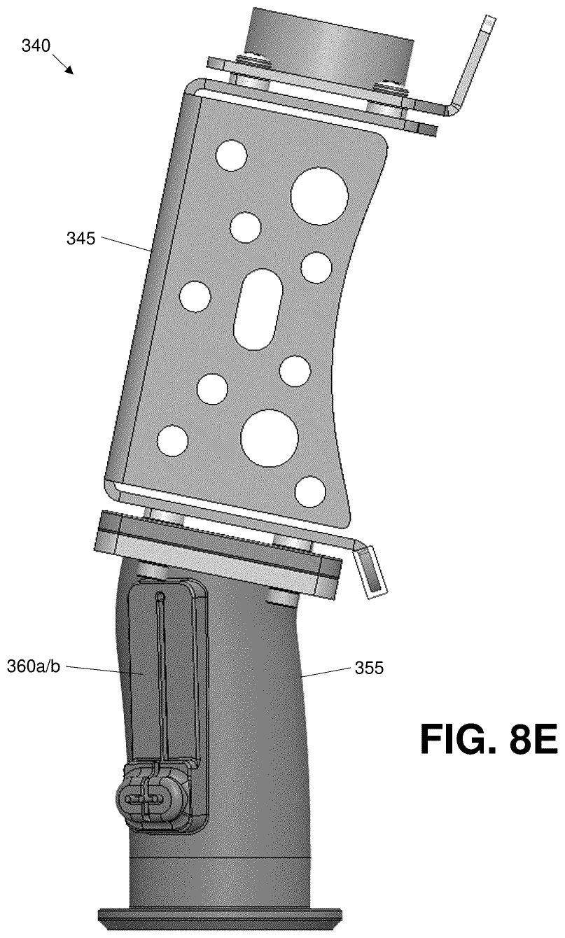

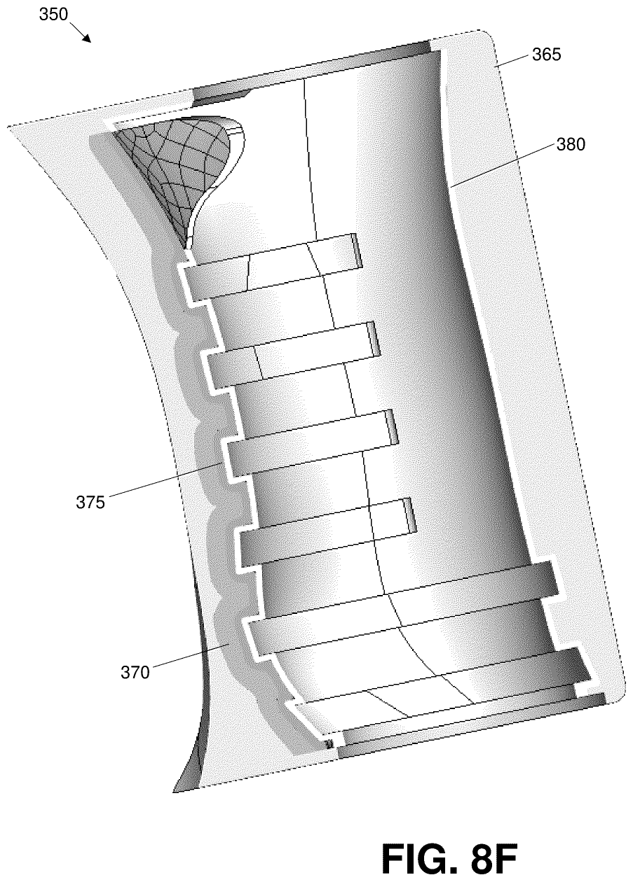

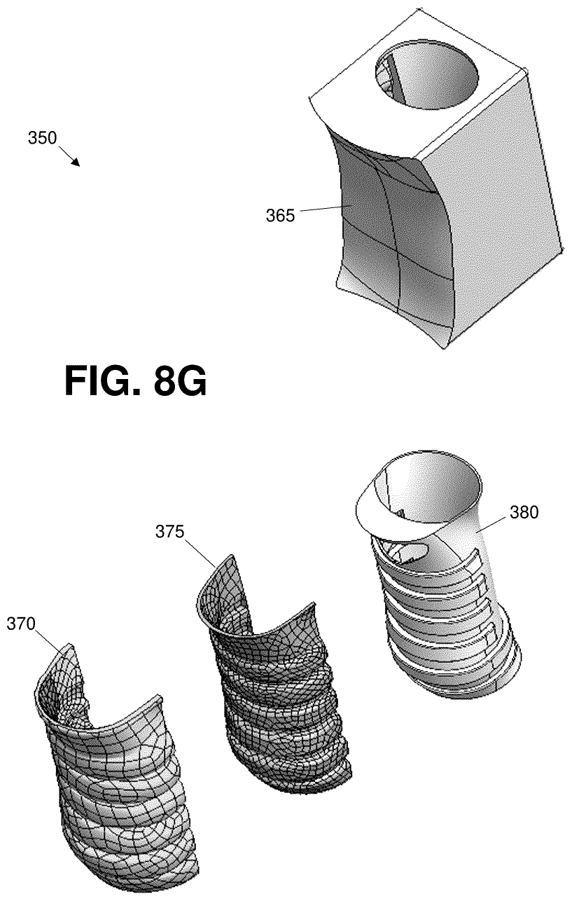

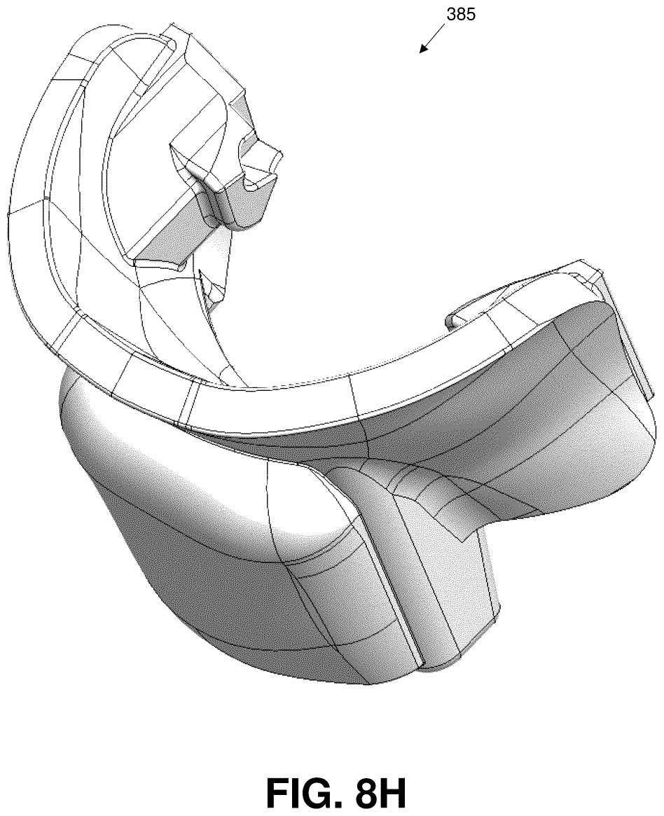

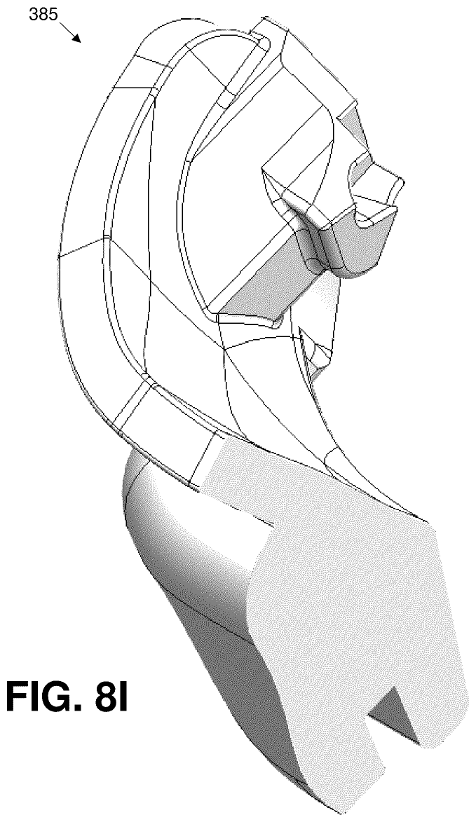

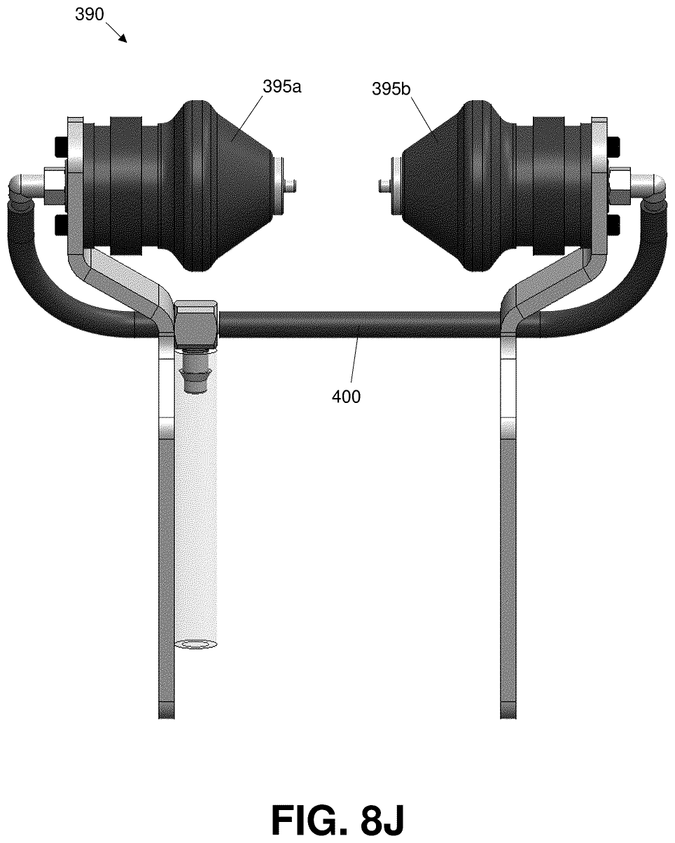

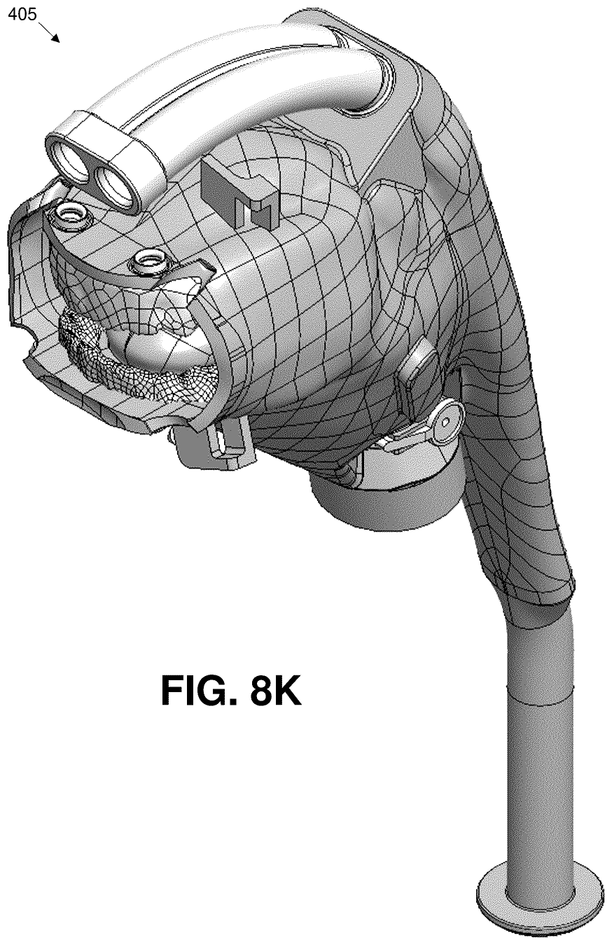

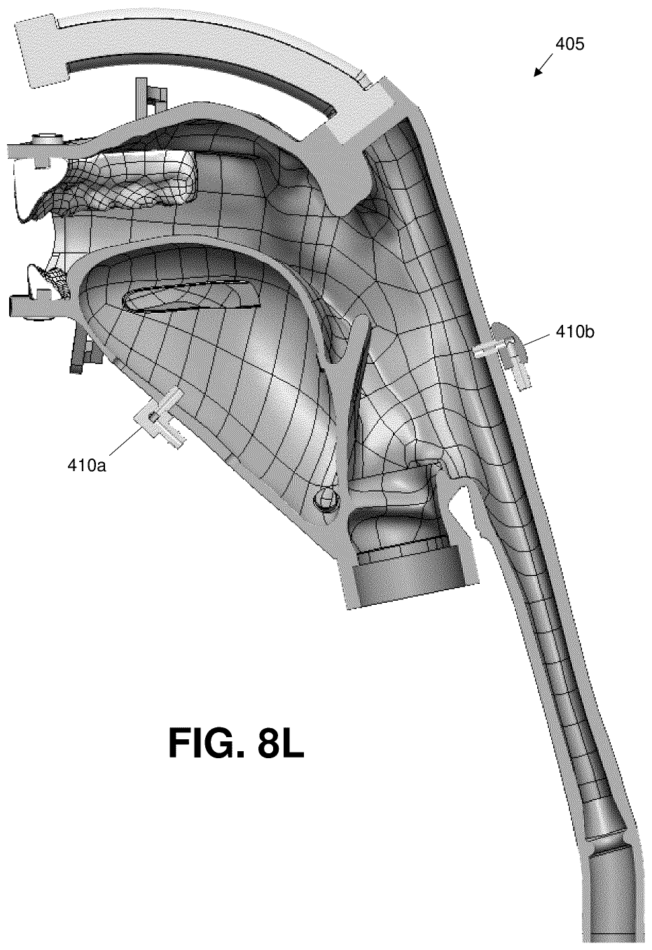

Referring to FIG. 8A, with continuing reference to FIGS. 1A-1E, a perspective view of the airway subsystem 135 of the head and neck system 100 for the patient simulator is illustrated, according to one or more embodiments of the present disclosure.

Referring to FIG. 8B, with continuing reference to FIG. 8A, an exploded perspective view of the airway subsystem 135 is illustrated, according to one or more embodiments of the present disclosure.

Referring to FIG. 8C, with continuing reference to FIGS. 8A-8B, a perspective view of a trachea assembly 340 of the airway subsystem 135 is illustrated, according to one or more embodiments of the present disclosure. The trachea assembly 340 includes a frame 345 adapted to receive a simulated trachea insert 350 and a lower trachea tube 355. In one or more embodiments, one or more (e.g., a vertically-spaced-apart pair) of intubation depth sensors 360a-b are mounted to the lower trachea tube 355. The one or more controllers 145 communicate with the intubation depth sensor(s) 360a-b.

Referring to FIG. 8D, with continuing reference to FIG. 8C, a cross-sectional side elevation view of the trachea assembly 340 is illustrated, according to one or more embodiments of the present disclosure.

Referring to FIG. 8E, with continuing reference to FIG. 8C, another side elevation view of the trachea assembly 340 is illustrated, according to one or more embodiments of the present disclosure.

Referring to FIG. 8F, with continuing reference to FIGS. 8A-8B, a cross-sectional side elevation view of the simulated trachea insert 350 of the airway subsystem 135 is illustrated, according to one or more embodiments of the present disclosure, which simulated trachea insert 350 includes a skin layer 365, an adipose (or fat) layer 370, a tissue layer 375, and a tracheal layer 380.

Referring to FIG. 8G, with continuing reference to FIG. 8F, an exploded perspective view of the simulated trachea insert 350 is illustrated, according to one or more embodiments of the present disclosure.

Referring to FIG. 8H, with continuing reference to FIGS. 8A-8B, a perspective view of a simulated vocal chords insert 385 of the airway subsystem 135 is illustrated, according to one or more embodiments of the present disclosure.

Referring to FIG. 8I, with continuing reference to FIG. 8H, a cross-sectional perspective view of the simulated vocal chords insert 385 is illustrated, according to one or more embodiments of the present disclosure.

Referring to FIG. 8J, with continuing reference to FIGS. 8A-8B, a front elevation view of a laryngospasm assembly 390 of the airway subsystem 135 is illustrated, according to one or more embodiments of the present disclosure. The laryngospasm assembly 390 includes a pair of bladders 395a-b in communication via tubing 400 with an air supply (e.g., a compressor; not shown) of the patient simulator, which air supply is controllable by the one or more controllers 145 to simulate life-like human laryngospasm-ing.

Referring to FIG. 8K, with continuing reference to FIGS. 8A-8B, a perspective view of a simulated nose and throat assembly 405 of the airway subsystem 135 is illustrated, according to one or more embodiments of the present disclosure. The simulated nose and throat assembly 405 includes a pair of fittings 410a-b (shown in FIG. 8L) in communication via tubing (not shown) with an air supply (e.g., a compressor; not shown) of the patient simulator, which air supply is controllable by the one or more controllers 145 to simulate life-like human throat swelling and airway pressure, respectively.

Referring to FIG. 8L, with continuing reference to FIG. 8K, a cross-sectional side elevation view of the simulated nose and throat assembly 405 is illustrated, according to one or more embodiments of the present disclosure.

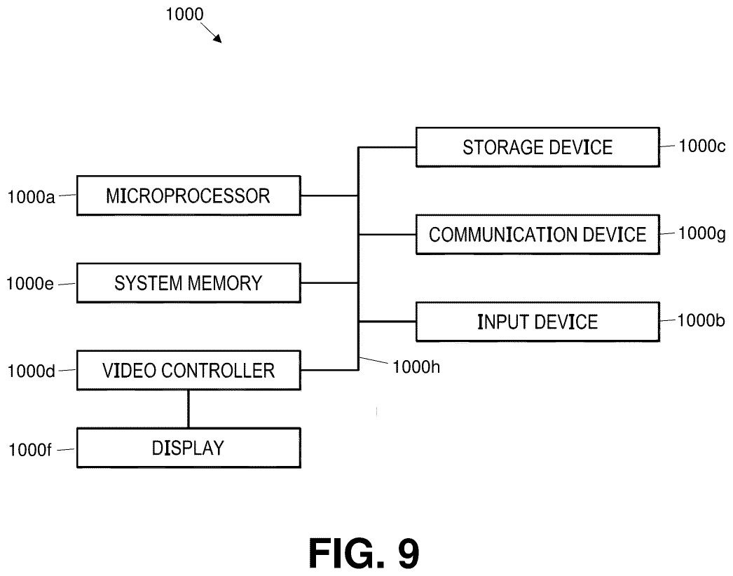

Referring to FIG. 9, with continuing reference to FIGS. 1A through 8L, in one or more embodiments, a computing node 1000 for implementing one or more of the above-described embodiments, and/or any combination thereof, is depicted. In one or more embodiments, the node 1000 is, includes, or is part of the one or more controllers 145 shown and described above in connection with FIGS. 1A-1E. The node 1000 includes a microprocessor 1000a, an input device 1000b, a storage device 1000c, a video controller 1000d, a system memory 1000e, a display 1000f, and a communication device 1000g all interconnected by one or more buses 1000h. In one or more embodiments, the microprocessor 1000a is, includes, or is part of, the phantom and/or the instruments described herein. In one or more embodiments, the storage device 1000c may include a floppy drive, hard drive, CD-ROM, optical drive, any other form of storage device or any combination thereof. In one or more embodiments, the storage device 1000c may include, and/or be capable of receiving, a floppy disk, CD-ROM, DVD-ROM, or any other form of computer-readable medium that may contain executable instructions. In one or more embodiments, the communication device 1000g may include a modem, network card, or any other device to enable the node 1000 to communicate with other nodes. In one or more embodiments, any node represents a plurality of interconnected (whether by intranet or Internet) computer systems, including without limitation, personal computers, mainframes, PDAs, smartphones and cell phones.

In one or more embodiments, one or more of the components of any of the above-described embodiments include at least the node 1000 and/or components thereof, and/or one or more nodes that are substantially similar to the node 1000 and/or components thereof. In one or more embodiments, one or more of the above-described components of the node 1000 and/or the above-described embodiments include respective pluralities of same components.

In one or more embodiments, a computer system includes at least hardware capable of executing machine readable instructions, as well as the software for executing acts (typically machine-readable instructions) that produce a desired result. In one or more embodiments, a computer system includes hybrids of hardware and software, as well as computer sub-systems.

In one or more embodiments, hardware generally includes at least processor-capable platforms, such as client-machines (also known as personal computers or servers), and hand-held processing devices (such as smart phones, tablet computers, personal digital assistants (PDAs), or personal computing devices (PCDs), for example). In one or more embodiments, hardware may include any physical device that is capable of storing machine-readable instructions, such as memory or other data storage devices. In one or more embodiments, other forms of hardware include hardware sub-systems, including transfer devices such as modems, modem cards, ports, and port cards, for example.

In one or more embodiments, software includes any machine code stored in any memory medium, such as RAM or ROM, and machine code stored on other devices (such as floppy disks, flash memory, or a CD ROM, for example). In one or more embodiments, software may include source or object code. In one or more embodiments, software encompasses any set of instructions capable of being executed on a node such as, for example, on a client machine or server.

In one or more embodiments, combinations of software and hardware could also be used for providing enhanced functionality and performance for certain embodiments of the present disclosure. In one or more embodiments, software functions may be directly manufactured into a silicon chip. Accordingly, combinations of hardware and software are also included within the definition of a computer system and are thus envisioned by the present disclosure as possible equivalent structures and equivalent methods.

In one or more embodiments, computer readable mediums include, for example, passive data storage, such as a random-access memory (RAM) as well as semi-permanent data storage such as a compact disk read only memory (CD-ROM). One or more embodiments of the present disclosure may be embodied in the RAM of a computer to transform a standard computer into a new specific computing machine. In one or more embodiments, data structures are defined organizations of data that may enable one or more embodiments of the present disclosure. In one or more embodiments, data structure may provide an organization of data, or an organization of executable code.

In one or more embodiments, any networks and/or one or more portions thereof, may be designed to work on any specific architecture. In one or more embodiments, one or more portions of any networks may be executed on a single computer, local area networks, client-server networks, wide area networks, internets, hand-held and other portable and wireless devices and networks.

In one or more embodiments, database may be any standard or proprietary database software. In one or more embodiments, the database may have fields, records, data, and other database elements that may be associated through database specific software. In one or more embodiments, data may be mapped. In one or more embodiments, mapping is the process of associating one data entry with another data entry. In one or more embodiments, the data contained in the location of a character file can be mapped to a field in a second table. In one or more embodiments, the physical location of the database is not limiting, and the database may be distributed. In one or more embodiments, the database may exist remotely from the server, and run on a separate platform. In one or more embodiments, the database may be accessible across the Internet. In one or more embodiments, more than one database may be implemented.

In one or more embodiments, a plurality of instructions stored on a non-transitory computer readable medium may be executed by one or more processors to cause the one or more processors to carry out or implement in whole or in part the above-described operation of each of the above-described embodiments, and/or any combination thereof. In one or more embodiments, such a processor may be or include one or more of the microprocessor 1000a, one or more other controllers, such as the one or more controllers 145 shown and described above in connection with FIGS. 1A-1E, any processor(s) that are part of the components of the above-described embodiments, and/or any combination thereof, and such a computer readable medium may be distributed among one or more components of the above-described systems. In one or more embodiments, such a processor may execute the plurality of instructions in connection with a virtual computer system. In one or more embodiments, such a plurality of instructions may communicate directly with the one or more processors, and/or may interact with one or more operating systems, middleware, firmware, other applications, and/or any combination thereof, to cause the one or more processors to execute the instructions.

One or more embodiments of the present application are provided in whole or in part as described in the Appendix of the '107 Application, which forms part of the present application. It is understood that one or more of the embodiments described above and shown FIGS. 1A through 9 may be combined in whole or in part with one or more of the embodiments described and illustrated in the Appendix of the '107 Application, and/or one or more of the other embodiments described above and shown in FIGS. 1A through 9.

A system for a patient simulator has been disclosed according to one or more embodiments of the present disclosure. The system generally includes: a simulated head; and a simulated neck to which the simulated head is operably coupled, the simulated neck including: a neck linkage assembly; and a plurality of neck actuators, wherein the plurality of neck actuators are adapted to move the neck linkage assembly to impart yaw, pitch, and roll motions to the simulated head, and wherein the plurality of neck actuators includes: (i) a rotational actuator; and a rotational actuation rod via which the rotational actuator is adapted to move the neck linkage assembly to impart the yaw motion to the simulated head; (ii) a plurality of linear actuators; and a plurality of linear actuation rods via which respective ones of the plurality of linear actuators are adapted to move the neck linkage assembly to impart the pitch and roll motions to the simulated head; or (iii) both (i) and (i). In one or more embodiments, the plurality of neck actuators includes: (i) the rotational actuator; and the rotational actuation rod via which the rotational actuator is adapted to move the neck linkage assembly to impart the yaw motion to the simulated head; and the rotational actuation rod extends through a central passageway of the neck linkage assembly. In one or more embodiments, the plurality of neck actuators includes: (ii) the plurality of linear actuators; and the plurality of linear actuation rods via which respective ones of the plurality of linear actuators are adapted to move the neck linkage assembly to impart the pitch and roll motions to the simulated head; and respective ones of the plurality of linear actuation rods extend through corresponding peripheral passageways of the neck linkage assembly. In one or more embodiments, the plurality of neck actuators includes: (iii) both (i) and (i). In one or more embodiments, the neck linkage assembly includes a segmented series of links operably coupling the simulated head of the patient simulator to a simulated torso of the patient simulator. In one or more embodiments, the system further includes one or more simulated skin layers covering the simulated head and the simulated neck.

A method for imparting yaw, pitch, and roll motions to a simulated head of a patient simulator has also been disclosed according to one or more embodiments of the present disclosure. The method generally includes: moving a neck linkage assembly of a simulated neck of the patient simulator using a rotational actuator to impart the yaw motion to the simulated head of the patient simulator, the simulated head being operably coupled to the neck linkage assembly of the simulated neck; and moving the neck linkage assembly of the simulated neck of the patient simulator using a plurality of linear actuators to impart the pitch and roll motions to the simulated head of the patient simulator. In one or more embodiments, the rotational actuator imparts the yaw motion to the simulated head of the patient simulator by moving a rotational actuation rod. In one or more embodiments, the rotational actuation rod extends through a central passageway of the neck linkage assembly. In one or more embodiments, respective ones of the plurality of linear actuators impart the pitch and roll motions to the simulated head of the patient simulator by moving respective ones of a plurality of linear actuation rods. In one or more embodiments, respective ones of the plurality of linear actuation rods extend through corresponding peripheral passageways of the neck linkage assembly. In one or more embodiments, the rotational actuator imparts the yaw motion to the simulated head of the patient simulator by moving a rotational actuation rod; and respective ones of the plurality of linear actuators impart the pitch and roll motions to the simulated head of the patient simulator by moving respective ones of a plurality of linear actuation rods. In one or more embodiments, the neck linkage assembly includes a segmented series of links operably coupling the simulated head of the patient simulator to a simulated torso of the patient simulator.

A simulated neck for imparting yaw, pitch, and roll motions to a simulated head of a patient simulator has also been disclosed according to one or more embodiments of the present disclosure. The simulated neck generally includes: a neck linkage assembly to which the simulated head is operably coupled; a rotational actuator adapted to move the neck linkage assembly to impart the yaw motion to the simulated head of the patient simulator; and a plurality of linear actuators adapted to move the neck linkage assembly to impart the pitch and roll motions to the simulate head of the patient simulator. In one or more embodiments, the rotational actuator is adapted to impart the yaw motion to the simulated head of the patient simulator by moving a rotational actuation rod. In one or more embodiments, the rotational actuation rod extends through a central passageway of the neck linkage assembly. In one or more embodiments, respective ones of the plurality of linear actuators are adapted to impart the pitch and roll motions to the simulated head of the patient simulator by moving respective ones of a plurality of linear actuation rods. In one or more embodiments, respective ones of the plurality of linear actuation rods extend through corresponding peripheral passageways of the neck linkage assembly. In one or more embodiments, the rotational actuator is adapted to impart the yaw motion to the simulated head of the patient simulator by moving a rotational actuation rod; and respective ones of the plurality of linear actuators are adapted to impart the pitch and roll motions to the simulated head of the patient simulator by moving respective ones of a plurality of linear actuation rods. In one or more embodiments, the neck linkage assembly includes a segmented series of links operably coupling the simulated head of the patient simulator to a simulated torso of the patient simulator.

A patient simulator including a head and neck system has been disclosed according to one or more embodiments of the present disclosure. In one or more embodiments, the patient simulator further includes one or more simulated skin layers adapted to cover the head and neck system, according to one or more embodiments of the present disclosure.

A head and neck system has been disclosed according to one or more embodiments of the present disclosure. In one or more embodiments, the head and neck system includes a jaw movement subsystem, according to one or more embodiments of the present disclosure. In one or more embodiments, the jaw movement system is adapted to interface with one or more simulated skin layers covering the head and neck system, according to one or more embodiments of the present disclosure.

A jaw movement system has been disclosed according to one or more embodiments of the present disclosure.

A sweat and tears system has been disclosed according to one or more embodiments of the present disclosure.

A neck movement system has been disclosed according to one or more embodiments of the present disclosure.

An eyes system has been disclosed according to one or more embodiments of the present disclosure.

A blink movement assembly has been disclosed according to one or more embodiments of the present disclosure.

An eye assembly has been disclosed according to one or more embodiments of the present disclosure. In one or more embodiments, the eye assembly includes a simulated eye and an eye movement subassembly.

An eye movement assembly has been disclosed according to one or more embodiments of the present disclosure.

A simulated eye has been disclosed according to one or more embodiments of the present disclosure.

A brow movement system has been disclosed according to one or more embodiments of the present disclosure.

A lip movement system has been disclosed according to one or more embodiments of the present disclosure.

An airway system has been disclosed according to one or more embodiments of the present disclosure.

A trachea assembly has been disclosed according to one or more embodiments of the present disclosure.

A simulated trachea insert has been disclosed according to one or more embodiments of the present disclosure.

A simulated vocal chords insert has been disclosed according to one or more embodiments of the present disclosure.

A laryngospasm assembly has been disclosed according to one or more embodiments of the present disclosure.

A simulated nose and throat assembly has been disclosed according to one or more embodiments of the present disclosure.

An apparatus has been disclosed according to one or more embodiments of the present disclosure.

A method has been disclosed according to one or more embodiments of the present disclosure.

A system has been disclosed according to one or more embodiments of the present disclosure.

An assembly has been disclosed according to one or more embodiments of the present disclosure.

The present disclosure further includes the following aspects:
Aspect 1. A system for a patient simulator, the system comprising:
   a simulated head; and
   a simulated neck to which the simulated head is operably coupled, the simulated
      neck comprising:
      a neck linkage assembly; and
      a plurality of neck actuators,
   wherein the plurality of neck actuators are adapted to move the neck linkage assembly to impart yaw, pitch, and roll motions to the simulated head, and
   wherein the plurality of neck actuators comprises:
      (i) a rotational actuator; and
         a rotational actuation rod via which the rotational actuator is adapted to move the neck linkage assembly to impart the yaw motion to the simulated head;
      (ii) a plurality of linear actuators; and
         a plurality of linear actuation rods via which respective ones of the plurality of linear actuators are adapted to move the neck linkage assembly to impart the pitch and roll motions to the simulated head;
      or
      (iii) both (i) and (i).
Aspect 2. The system of aspect 1, wherein the plurality of neck actuators comprises:
   (i) the rotational actuator; and
      the rotational actuation rod via which the rotational actuator is adapted to move the neck linkage assembly to impart the yaw motion to the simulated head;
   and
   wherein the rotational actuation rod extends through a central passageway of the neck linkage assembly.
Aspect 3. The system of aspect 1,
   wherein the plurality of neck actuators comprises:
      (ii) the plurality of linear actuators; and the plurality of linear actuation rods via which respective ones of the plurality of linear actuators are adapted to move the neck linkage assembly to impart the pitch and roll motions to the simulated head;
   and
   wherein respective ones of the plurality of linear actuation rods extend through corresponding peripheral passageways of the neck linkage assembly.
Aspect 4. The system of aspect 1,
   wherein the plurality of neck actuators comprises:
      (iii) both (i) and (i).
Aspect 5. The system of any of aspects 1-4, wherein the neck linkage assembly comprises a segmented series of links operably coupling the simulated head of the patient simulator to a simulated torso of the patient simulator.
Aspect 6. The system of any of aspects 1-4, further comprising one or more simulated skin layers covering the simulated head and the simulated neck.
Aspect 7. A method for imparting yaw, pitch, and roll motions to a simulated head of a patient simulator, the method comprising:
   moving a neck linkage assembly of a simulated neck of the patient simulator using a rotational actuator to impart the yaw motion to the simulated head of the patient simulator, the simulated head being operably coupled to the neck linkage assembly of the simulated neck;
   and
   moving the neck linkage assembly of the simulated neck of the patient simulator using a plurality of linear actuators to impart the pitch and roll motions to the simulated head of the patient simulator.
Aspect 8. The method of aspect 7, wherein the rotational actuator imparts the yaw motion to the simulated head of the patient simulator by moving a rotational actuation rod.
Aspect 9. The method of aspect 8, wherein the rotational actuation rod extends through a central passageway of the neck linkage assembly.
Aspect 10. The method of aspect 7, wherein respective ones of the plurality of linear actuators impart the pitch and roll motions to the simulated head of the patient simulator by moving respective ones of a plurality of linear actuation rods.
Aspect 11. The method of aspect 10, wherein respective ones of the plurality of linear actuation rods extend through corresponding peripheral passageways of the neck linkage assembly.
Aspect 12. The method of aspect 7, wherein the rotational actuator imparts the yaw motion to the simulated head of the patient simulator by moving a rotational actuation rod; and
   wherein respective ones of the plurality of linear actuators impart the pitch and roll motions to the simulated head of the patient simulator by moving respective ones of a plurality of linear actuation rods.
Aspect 13. The method of any of aspects 7-12, wherein the neck linkage assembly comprises a segmented series of links operably coupling the simulated head of the patient simulator to a simulated torso of the patient simulator.
Aspect 14. A simulated neck for imparting yaw, pitch, and roll motions to a simulated head of a patient simulator, the simulated neck comprising:
   a neck linkage assembly to which the simulated head is operably coupled;
   a rotational actuator adapted to move the neck linkage assembly to impart the yaw motion to the simulated head of the patient simulator; and
   a plurality of linear actuators adapted to move the neck linkage assembly to impart the pitch and roll motions to the simulate head of the patient simulator.
Aspect 15. The simulated neck of aspect 14, wherein the rotational actuator is adapted to impart the yaw motion to the simulated head of the patient simulator by moving a rotational actuation rod.
Aspect 16. The simulated neck of aspect 15, wherein the rotational actuation rod extends through a central passageway of the neck linkage assembly.
Aspect 17. The simulated neck of aspect 14, wherein respective ones of the plurality of linear actuators are adapted to impart the pitch and roll motions to the simulated head of the patient simulator by moving respective ones of a plurality of linear actuation rods.
Aspect 18. The simulated neck of aspect 17, wherein respective ones of the plurality of linear actuation rods extend through corresponding peripheral passageways of the neck linkage assembly.
Aspect 19. The simulated neck of aspect 14, wherein the rotational actuator is adapted to impart the yaw motion to the simulated head of the patient simulator by moving a rotational actuation rod; and
   wherein respective ones of the plurality of linear actuators are adapted to impart the pitch and roll motions to the simulated head of the patient simulator by moving respective ones of a plurality of linear actuation rods.
Aspect 20. The simulated neck of any of aspects 14-19, wherein the neck linkage assembly comprises a segmented series of links operably coupling the simulated head of the patient simulator to a simulated torso of the patient simulator.

It is further understood that variations may be made in the foregoing without departing from the scope of the disclosure.

In one or more embodiments, the elements and teachings of the various embodiments disclosed herein may be combined in whole or in part in some or all of said embodiment(s). In addition, one or more of the elements and teachings of the various embodiments disclosed herein may be omitted, at least in part, or combined, at least in part, with one or more of the other elements and teachings of said embodiment(s).

Any spatial references such as, for example, “upper,” “lower,” “above,” “below,” “between,” “bottom,” “vertical,” “horizontal,” “angular,” “upwards,” “downwards,” “side-to-side,” “left-to-right,” “left,” “right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In one or more embodiments, while different steps, processes, and procedures are described as appearing as distinct acts, one or more of the steps, one or more of the processes, or one or more of the procedures may also be performed in different orders, simultaneously or sequentially. In one or more embodiments, the steps, processes, or procedures may be merged into one or more steps, processes, or procedures. In one or more embodiments, one or more of the operational steps in each embodiment may be omitted. Moreover, in some instances, some features of the present disclosure may be employed without a corresponding use of the other features. Moreover, one or more of the embodiments disclosed above and in the Appendix of the '107 Application, or variations thereof, may be combined in whole or in part with any one or more of the other embodiments described above and in the Appendix of the '107 Application, or variations thereof.

Although various embodiments have been disclosed in detail above and in the Appendix of the '107 Application, the embodiments disclosed are exemplary only and are not limiting, and those skilled in the art will readily appreciate that many other modifications, changes, and substitutions are possible in the embodiments without materially departing from the novel teachings and advantages of the present disclosure. Accordingly, all such modifications, changes, and substitutions are intended to be included within the scope of this disclosure as defined in the following claims. In the claims, means-plus-function clauses are intended to cover the structures described herein as performing the recited function and not only structural equivalents, but also equivalent structures. Moreover, it is the express intention of the applicant not to invoke 35 U.S.C. § 112 (f) for any limitations of any of the claims herein, except for those in which the claim expressly uses the word “means” together with an associated function.

What is claimed is:

1. A system for a patient simulator, the system comprising:
a simulated head; and
a simulated neck to which the simulated head is operably coupled, the simulated neck comprising:
a neck linkage assembly; and
a plurality of neck actuators,
wherein the plurality of neck actuators are adapted to move the neck linkage assembly to impart yaw, pitch, and roll motions to the simulated head, and
wherein the plurality of neck actuators comprises:
(i) a rotational actuator; and
a rotational actuation rod via which the rotational actuator is adapted to move the neck linkage assembly to impart the yaw motion to the simulated head;
(ii) a plurality of linear actuators; and
a plurality of linear actuation rods via which respective ones of the plurality of linear actuators are adapted to move the neck linkage assembly to impart the pitch and roll motions to the simulated head;
or
(iii) both (i) and (i).

2. The system of claim 1,
wherein the plurality of neck actuators comprises:
(i) the rotational actuator; and
the rotational actuation rod via which the rotational actuator is adapted to move the neck linkage assembly to impart the yaw motion to the simulated head;
and
wherein the rotational actuation rod extends through a central passageway of the neck linkage assembly.

3. The system of claim 1,
wherein the plurality of neck actuators comprises:
(ii) the plurality of linear actuators; and
the plurality of linear actuation rods via which respective ones of the plurality of linear actuators are adapted to move the neck linkage assembly to impart the pitch and roll motions to the simulated head;
and
wherein respective ones of the plurality of linear actuation rods extend through corresponding peripheral passageways of the neck linkage assembly.

4. The system of claim 1,
wherein the plurality of neck actuators comprises:
(iii) both (i) and (i).

5. The system of claim 1, wherein the neck linkage assembly comprises a segmented series of links operably coupling the simulated head of the patient simulator to a simulated torso of the patient simulator.

6. The system of claim 1, further comprising one or more simulated skin layers covering the simulated head and the simulated neck.

7. A method for imparting yaw, pitch, and roll motions to a simulated head of a patient simulator, the method comprising:
moving a neck linkage assembly of a simulated neck of the patient simulator using a rotational actuator to impart the yaw motion to the simulated head of the patient simulator, the simulated head being operably coupled to the neck linkage assembly of the simulated neck;
and
moving the neck linkage assembly of the simulated neck of the patient simulator using a plurality of linear actuators to impart the pitch and roll motions to the simulated head of the patient simulator.

8. The method of claim 7, wherein the rotational actuator imparts the yaw motion to the simulated head of the patient simulator by moving a rotational actuation rod.

9. The method of claim 8, wherein the rotational actuation rod extends through a central passageway of the neck linkage assembly.

10. The method of claim 7, wherein respective ones of the plurality of linear actuators impart the pitch and roll motions to the simulated head of the patient simulator by moving respective ones of a plurality of linear actuation rods.

11. The method of claim 10, wherein respective ones of the plurality of linear actuation rods extend through corresponding peripheral passageways of the neck linkage assembly.

12. The method of claim 7, wherein the rotational actuator imparts the yaw motion to the simulated head of the patient simulator by moving a rotational actuation rod; and
wherein respective ones of the plurality of linear actuators impart the pitch and roll motions to the simulated head of the patient simulator by moving respective ones of a plurality of linear actuation rods.

13. The method of claim 7, wherein the neck linkage assembly comprises a segmented series of links operably coupling the simulated head of the patient simulator to a simulated torso of the patient simulator.

14. A simulated neck for imparting yaw, pitch, and roll motions to a simulated head of a patient simulator, the simulated neck comprising:
a neck linkage assembly to which the simulated head is operably coupled;
a rotational actuator adapted to move the neck linkage assembly to impart the yaw motion to the simulated head of the patient simulator; and
a plurality of linear actuators adapted to move the neck linkage assembly to impart the pitch and roll motions to the simulate head of the patient simulator.

15. The simulated neck of claim 14, wherein the rotational actuator is adapted to impart the yaw motion to the simulated head of the patient simulator by moving a rotational actuation rod.

16. The simulated neck of claim 15, wherein the rotational actuation rod extends through a central passageway of the neck linkage assembly.

17. The simulated neck of claim 14, wherein respective ones of the plurality of linear actuators are adapted to impart the pitch and roll motions to the simulated head of the patient simulator by moving respective ones of a plurality of linear actuation rods.

18. The simulated neck of claim 17, wherein respective ones of the plurality of linear actuation rods extend through corresponding peripheral passageways of the neck linkage assembly.

19. The simulated neck of claim 14, wherein the rotational actuator is adapted to impart the yaw motion to the simulated head of the patient simulator by moving a rotational actuation rod; and
wherein respective ones of the plurality of linear actuators are adapted to impart the pitch and roll motions to the simulated head of the patient simulator by moving respective ones of a plurality of linear actuation rods.

20. The simulated neck of claim 14, wherein the neck linkage assembly comprises a segmented series of links operably coupling the simulated head of the patient simulator to a simulated torso of the patient simulator.
